(19) United States
(12) Patent Application Publication
(10) Pub. No.: US 2026/0338363 A1
(43) Pub. Date: Oct. 29, 2026

(54) SENSOR INTEGRATED INTO LIGHTING STRUCTURE

(71) Applicant: LEDVANCE LLC, WILMINGTON, MA (US)

(72) Inventors: Tianzheng Jiang, Shenzhen (CN); Ming Li, Acton, MA (US)

(21) Appl. No.: 19/186,805

(22) Filed: Apr. 23, 2025

(51) Int. Cl. F21V 23/04; F21V 17/12; F21V 23/00; F21V 23/06

(52) U.S. Cl. CPC F21V 23/0442; F21V 17/12; F21V 23/003; F21V 23/06

(57) ABSTRACT

A sensor including a sensor element for reading elements from the ambient, and an engagement surface configured to reversibly couple with a port of a lighting structure. The sensor may also include a sensor electrical interface to reversibly mate with a power source interface in the port of the lighting structure. The sensor may further include a rechargeable sensor power source in electrical communication with a power circuit of the driver electronics in the lighting structure thorough the sensor electrical interface.

### TECHNICAL FIELD

The present invention relates generally to lighting structures, and in particular embodiments, to sensors that may be reversibly integrated into lighting structures.

### BACKGROUND

Improvements in lighting technology often rely on finite light sources (e.g., light-emitting diode (LED) devices) to generate light. In many applications, LED devices offer superior performance to conventional light sources (e.g., incandescent and halogen lamps). Further, light bulbs have become smarter in recent years. Many people are now replacing their standard incandescent bulb or classic LED bulb with smart bulb, which can be controlled wirelessly using smartphones or tablets. Additional functionality has now been considered as being added to light sources including light engines producing light using light emitting diodes.

### SUMMARY

In some embodiments, a lighting system is provided that includes a sensor that can be reversibly integrated into a lighting structure including a light engine including solid state emitters, such as light emitting diodes (LEDs).

In some embodiments, a lighting system is provided that includes a lighting structure and a sensor. In some embodiments, the lighting structure includes a housing including a lighting structure electrical interface and a light emission end. In some embodiments, the lighting structure includes a light engine within the housing including solid state emitters configured to emit light through the light emission end of the housing. In some embodiments, the lighting structure also includes a port including a first retaining surface and a power source interface, wherein the port is positioned for access to an ambient at an exterior of the housing. The lighting structure may also include driver electronics in electrical communication with the lighting structure electrical interface of the housing. The driver electronics can include a first power circuit to the light engine, and a second power circuit to the power source interface of the port. In some embodiments, the lighting system includes a sensor for reversible engagement to the port of the lighting structure. In some embodiments, the sensor includes a sensor element for reading elements from the ambient. The sensor may also include a second retaining surface, wherein the second retaining surface is configured to reversibly couple with the first retaining surface in the port of the lighting structure. The sensor may also include a sensor electrical interface to reversibly mate with the power source interface in the port of the lighting structure. The sensor may also include a rechargeable sensor power source in electrical communication with the second power circuit of the driver electronics in the lighting structure thorough the sensor electrical interface.

In another embodiment, a lighting system is provided that includes a lighting structure and a sensor. The lighting structure may include a housing including a lighting structure electrical interface and a light emission end, and a light engine within the housing including solid state emitters configured to emit light through the light emission end of the housing. The lighting structure may also include a port including a power source interface, in which the port is positioned for measuring an ambient from an exterior of the housing. In some embodiments, the power source interface of the ports includes a first engagement surface. In some embodiments, the lighting structure further includes driver electronics in electrical communication with the electrical interface of the housing, in which the driver electronics include a first power circuit to the light engine and a second power circuit to the power source interface of the port. In some embodiments, the lighting system includes a sensor for integration with the port of the lighting structure. For example, in some embodiments, the sensor includes a sensor element for reading elements from the ambient, and a sensor electrical interface including electrodes having a second retaining surface configured to reversibly couple with the first retaining surface in the power source interface of the port of the lighting structure, and a rechargeable sensor power source in electrical communication with the second power circuit of the driver electronics in the lighting structure thorough the sensor electrical interface when reversibly mated with the power source interface.

In another aspect, a sensor is provided for integration with the port of a lighting structure, in which the electrical interface between the port and the sensor is through pin electrodes. In some embodiments, the sensor includes a housing having a first diameter, wherein the housing of the sensor includes an electrical interface end and a sensor element end. In some embodiments, the electrical interface end of the housing including a cylindrical boss with a threaded sidewall. The cylindrical boss can have a second diameter that is less than the first diameter of the housing. The second diameter of the cylindrical bass and the male thread size for the threaded sidewall of the cylindrical boss can be configured for reversible engagement of the cylindrical boss to a lighting structure port, wherein the lighting structure port includes a mating female thread size, a recess for housing the second diameter of the cylindrical boss, and a port electrical connector. In some embodiments, the sensor includes pin electrodes that extend through a base surface of the cylindrical boss, in which the pin electrodes configured for reversibly mating with the port electrical connector. In some embodiments, the sensor element of the sensor is positioned to take samples from an ambient through the sensor element end of the housing, in which the sensor element in electrical communication with the pin electrodes. In some embodiments, the sensor includes a rechargeable power source within the housing, the rechargeable power source in electrical communication with the pin electrodes and the sensor element.

In yet another embodiment, a sensor is described that includes a housing having a first diameter, in which the housing has an electrical interface end and a sensor element end. The he electrical interface end of the housing includes a cylindrical boss with a threaded sidewall. In some embodiments, the cylindrical boss has a second diameter that is less than the first diameter. The second diameter and male thread size for the threaded sidewall is configured for reversible engagement to a port of a separate lighting structure. In some embodiments, the port includes a mating female thread size, and a recess for housing the second diameter of the cylindrical boss and a port electrical connector. The sensor may further include a male cylindrically shaped connector extending through a base surface of the cylindrical boss. In some embodiments, the male cylindrically shaped connector includes a tip contact and at least one ring contact, wherein the tip contact is electrically isolated from the at least one ring contact, wherein the male cylindrically shaped connector is configured for reversibly mating with the port electrical connector. In some embodiments, the sensor also includes a sensor element positioned to take samples from an ambient through the sensor element end of the housing, in which the sensor element in electrical communication with the male cylindrically shaped boss. In some embodiments, the sensor also includes a rechargeable power source within the housing in electrical communication with the male cylindrically shaped connector, and the sensor element. In some examples, the sensor element provides a type for the sensor that is selected from the group consisting of dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof.

In a yet further embodiment, a sensor is provided that includes a housing including an electrical interface end and a sensor element end, in which the electrical interface end includes a cylindrical recess. In some embodiments, the cylindrical recess includes a sidewall with at least one retaining tab, wherein the at least one retaining tab is configured for reversible engagement to at least one retaining notch in a port of a separate lighting structure. The port may further include an electrical socket that includes an electrical contact portion and a latch portion. In some embodiments, the sensor includes electrodes extending through a base surface of the cylindrical recess at the electrical interface end of the housing, the electrodes including vertically orientated portion extending from the base surface of the cylindrical recess, and a horizontally orientated retention beam at an opposing end of the vertically orientated portion of the electrodes from the base surface of the cylindrical recess, in which the horizontally orientated retention beam is configured to reversibly lock into the latch portion of the electrical socket with rotation motion. In some embodiments, the sensor further includes a sensor element positioned to take samples from an ambient through the sensor element end, wherein the sensor element in electrical communication with the electrodes. In some embodiments, the sensor also includes a rechargeable power source within the housing in electrical communication with the electrodes, and the sensor element. In some examples, the electrodes are curved blade electrodes. In some examples, the cylindrical recess of the housing is a counterbore dimensioned to house a cylindrical protrusion of the port, wherein at least one retention tab is present on a sidewall of the counterbore. In some examples, the at least one retaining notch of the port includes a vertically orientated insertion portion and a horizontally orientated locking portion. In some examples, the sensor element is selected from the group consisting of dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a side view illustrating a lighting structure including a PIR port, in accordance with some embodiments.

FIG. 2 is a bottom up perspective view illustrating a high bay light fixture including a PIR port, in accordance with some embodiments.

FIG. 3 is a circuit diagram of the driver electronics within the housing of a lighting structure, in accordance with some embodiments.

FIG. 4 is a perspective view of a light engine over a lighting structure under an optic, in accordance with some embodiments.

FIG. 5 is a perspective view of a light engine, in accordance with some embodiments.

FIG. 6 is a perspective view of a sensor for engagement to the lighting structure depicted in FIG. 1, in accordance with some embodiments.

FIG. 7 is a perspective view of the three pin electrode connector of a sensor, in accordance with some embodiments.

FIG. 8 is a perspective view of a male cylindrically shaped electrode connector of a sensor, in accordance with some embodiments.

FIG. 9 is a perspective view of a twist lock electrode connector of a sensor, in accordance with some embodiments.

FIG. 10 is an exploded view of a sensor, in accordance with some embodiments.

FIG. 11 is a perspective view of a sensor circuit board, in accordance with some embodiments.

FIG. 12 is a circuit diagram of the driver electronics of a sensor, in accordance with some embodiments.

FIG. 13 is a circuit diagram of the driver electronics of a sensor including a smart module, in accordance with some embodiments.

FIG. 14 is a perspective view of the pin electrodes of a sensor, in accordance with some embodiments.

FIG. 15 is a perspective view of the port on the lighting structure for engagement with the sensor, in which the port includes concentric electrodes, in accordance with some embodiments.

FIG. 16 is a perspective view of connecting the sensor depicted in FIG. 14 to the port of the lighting structure depicted in FIG. 15, in accordance with some embodiments.

FIG. 17 is a perspective view of the male cylindrical shaped electrode of a sensor, in accordance with some embodiments.

FIG. 18 is a perspective view of the port on the lighting structure including a cylindrical jack, in accordance with some embodiments.

FIG. 19 is a perspective view of connecting the sensor depicted in FIG. 17 to the port of the lighting structure depicted in FIG. 158 in accordance with some embodiments.

FIG. 20 is a perspective view of the port of a lighting structure depicting a twist lock jack, in accordance with some embodiments.

FIG. 21 is a perspective view of a twist lock plug of a sensor for engagement to the lighting structure depicted in FIG. 20.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Embodiments will now be discussed with respect to certain embodiments in which a sensor is integrated into a lighting structure, e.g., through a port that allows for reversible engagement of the sensor to the lighting structure. As used herein, the term “reversible” denotes that the sensor and the lighting structure may be connected to one another and may be detached from one another. Reversible as used herein can include reversibly connected, reversibly engaged, and/or reversibly mating. As will be further described below, in some embodiments, reversible engagement may be provided by mechanical and/or electrical connectivity of a sensor used for detecting hazards in ambient environments to a port of a lighting structure that may have previously been configured for motion sensors.

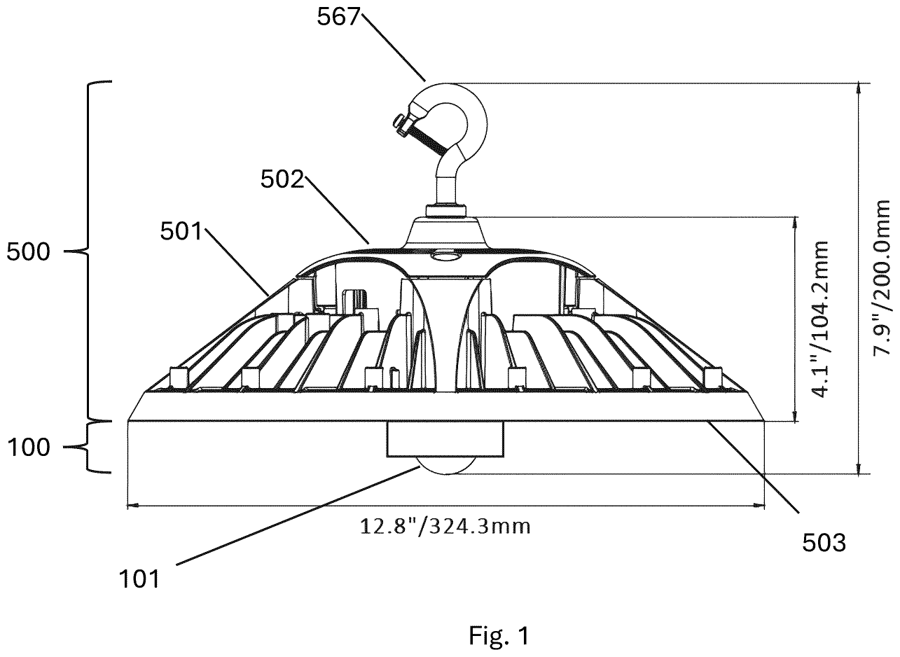

The embodiments presented herein are intended to be illustrative and are not intended to limit the embodiments to the precise descriptions as discussed. Rather, the embodiments discussed may be incorporated into a wide variety of implementations, such as lighting structures including light emitting diode (LED) containing light engines in general, and all such implementations are fully intended to be included within the scope of the embodiments. The structures, systems and methods that are provided herein are now described in more detail with reference to FIGS. 1-21.

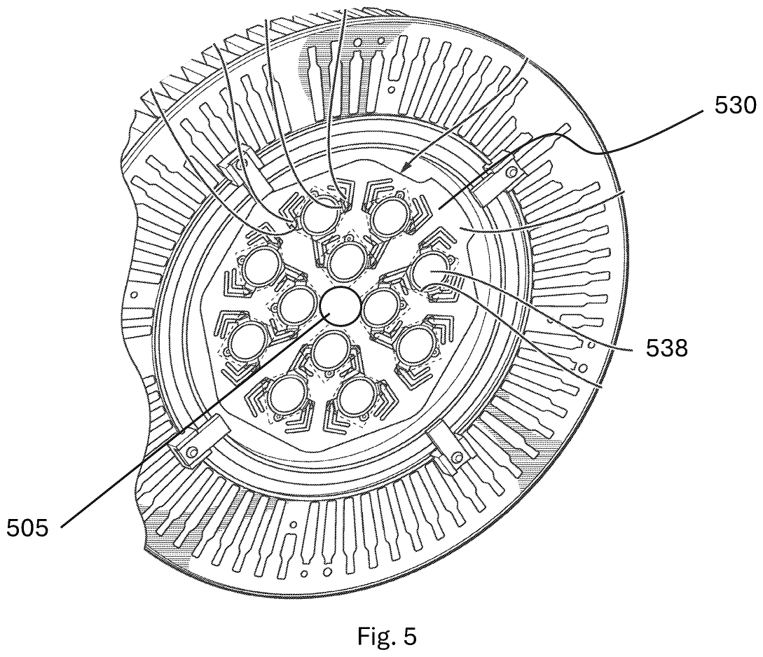

Referring to FIG. 1, in some embodiments, the lighting system includes a lighting structure 500 that includes a housing 501 including a lighting structure electrical interface 502 and a light emission end 503. The lighting structure 500 further includes a light engine 530 (see FIG. 5) that is contained within the housing 501. In some embodiments, the light engine 530 includes solid state emitters configured to emit light through the light emission end 503 of the housing 501. In some embodiments, the lighting structure 500 includes a port 505 including a first retaining surface 507 and a power source interface 506, in which the port 505 is positioned for access to an ambient at an exterior of the housing 501. In some embodiments, the lighting structure 500 also includes driver electronics 515 (see FIG. 3) in electrical communication with the lighting structure electrical interface 502 of the housing 501. In some embodiments, the driver electronics 515 including a driver 516, a first power circuit 517 to the light engine 530, and a second power circuit 518 to the power source interface 506 of the port 505.

FIG. 1 is a perspective view illustrating a lighting structure 500, e.g., high bay light fixture, including a port 505. In some examples when the lighting structure 500 is a high bay light fixture, the high bay light fixture may include a light source (e.g., light engine 530), a housing 501 to direct light downward, and a mounting system 567 (chains, hooks, or pendant mounts). High bay lights can be used to light up spaces whose ceilings are higher than 20 ft from the floor and can be around 40 ft from the floor.

The high bay light fixtures illustrated in the supplied figures are provided for illustrative purposes only. As will be recognized by those skilled in the art, any type of solid-state lighting fixture may be utilized with the methods, systems and structures for mating sensors 100 to lighting structures 500 that are described herein. By way of non-limiting example, the lighting structures 500 described herein may be for industrial or residential use in any form, including, but not limited to a high bay light fixture, troffer, wall pack, canopy luminaire, linear light fixture, flood luminaire, area luminaire, bollard, pendant light fixture, and so forth, which may be mounted in any manner, including, but not limited to, ceiling mounted, wall mounted, pole mounted, suspended, and so forth. In addition, the lighting structure 500 may be for indoor or outdoor use.

The housing 501 may be composed of a rigid material, e.g., a metal or polymeric material (e.g., plastic). The housing 501 may be a unitary structure, e.g., composed of a single material, or the housing 501 may be a multi-component structure. The housing 501 may be constructed to conform with an enclosure rating. For example, the housing 501 can be constructed to conform with an IP66 enclosure rating. For example, IP66 is one of the higher NEMA Ingress Protection ratings for an enclosure used in electronics, in which the enclosure is rated to be (i) dust tight with no ingress of dust for two to eight hours, and (ii) protected from water from heavy seas or water projected in powerful jets not entering the enclosure in harmful quantities. It is noted that this is only one example of an enclosure rating that the housing 51 can be instructed to meet. Other such enclosure standards that are or may become available can be suitable for the construction of the housing 501.

In some embodiments, the housing 501 of the lighting structure 500 includes port 505 that can be provided by a socket. In some embodiments, the socket is factory-installed during manufacturing of the lighting structure 500. In some embodiments, the socket is located on a surface of the housing 501 which is externally accessible without the need for removal of surrounding structure or elements, such as wall panels, ceiling tiles, brackets, and so forth. For example, as shown in FIGS. 1, 2 and 4, the socket that provides the port 505 may be located on a downward facing surface of the housing 501, with the solid-state lighting structure 500 being a high bay light fixture, thus, being accessible without need for removing ceiling tiles or accessing a rear portion of the lighting structure 500. Alternatively, the socket provided by the port 505 may be located internally on the housing 501, e.g., where the lighting structure 500 is intended for outdoor use. This protects the socket (port 505) from exposure to moisture. In some embodiments, with internal mounting, the port 505 may be accessible with removal of minimal parts, such as being located behind an access panel that can be removed without disassembly of the lighting structure 500.

In some embodiments, the lighting structure 500 may include be a solid-state lighting fixture assembly, e.g., a lighting structure including a light engine with a light source provided by solid state light emitters. The term “solid state” refers to light emitted by solid-state electroluminescence, as opposed to incandescent bulbs (which use thermal radiation) or fluorescent tubes, which use a low pressure Hg discharge. Compared to incandescent lighting, solid state lighting creates visible light with reduced heat generation and less energy dissipation. Some examples of solid state light emitters that are suitable for the methods and structures described herein include inorganic semiconductor light-emitting diodes (LEDs), organic light-emitting diodes (OLED), polymer light-emitting diodes (PLED) or combinations thereof. Although the following description describes an embodiment in which the solid-state light emitters are provided by light emitting diodes (LEDs), any of the aforementioned solid-state light emitters may be substituted for the LEDs.

In some embodiments, the housing 501 includes a first end, e.g., a lighting structure electrical interface 502, and a second end e.g., light emission end 503. In some embodiments, lighting structure electrical interface 502 provides the connection point for a main power connection from the power source to the lighting structure 500. For example, the main power wire may provide to the lighting structure 500 a universal input voltage, e.g., a voltage ranging from 120V to 277V. In some further examples, the main power wire may provide an input voltage of 347V. An input voltage of 120-277V can be suitable for commercial applications. In some embodiments, the input voltage can be 120V, which can be suitable for both residential and commercial applications.

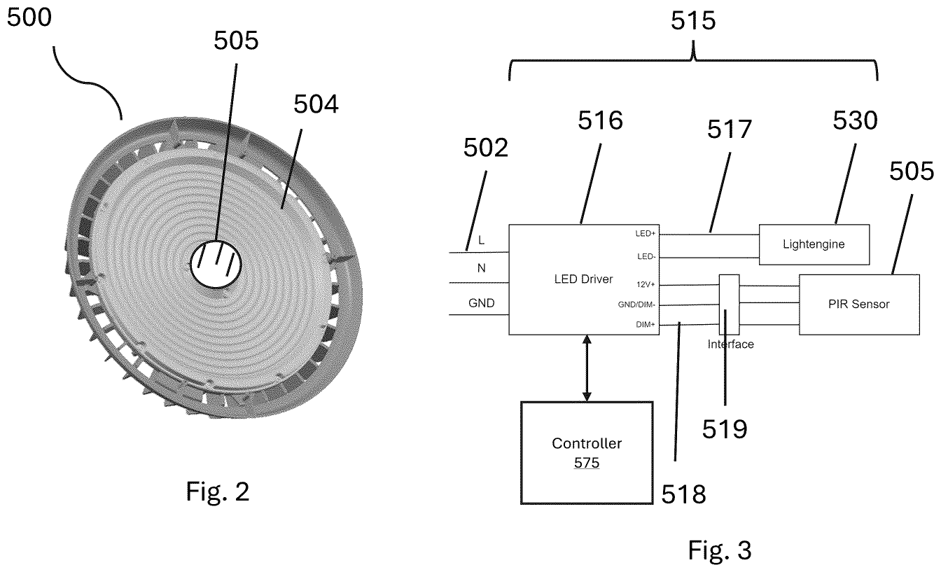

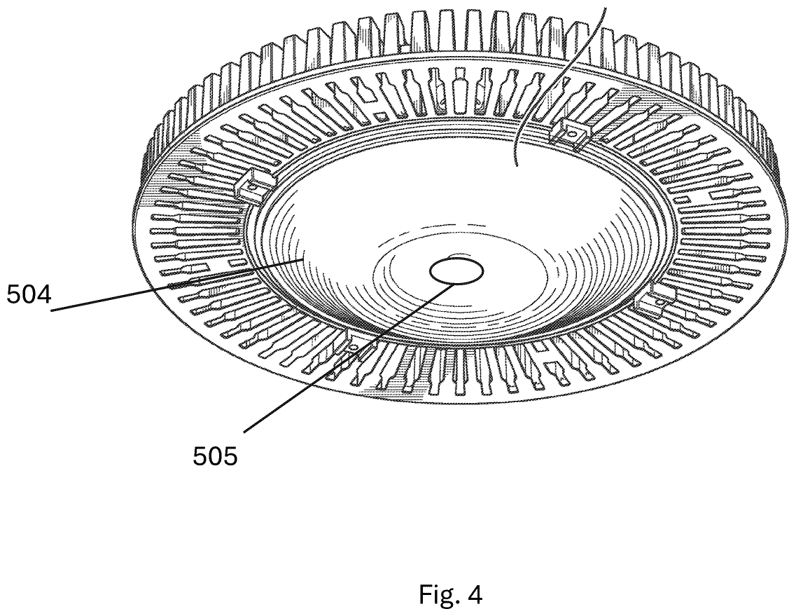

The second end, e.g., light emission end 503, of the housing 501 of the lighting structure 500 is the end of the lighting structure 500 through which light that is generated by the light engine 530 is projected. In some embodiments, the light emission end 503 may further include an optic 504, as depicted in FIGS. 2 and 4. The optic 504 may be composed of a glass or plastic material and may be positioned to cover the light engine 430 within the housing 501. The optic 504 may also be referred to as a lens.

In some embodiments, the housing 501 of the lighting structure 500 houses the light engine 530. In some embodiments, the light engine 530 may include a single light emitting diode as a single emitter, or a plurality of light emitting didoes (LEDs) can be a package in an array of LEDs.

Referring to FIG. 5, in some embodiments, the light engine 530 can include emitters arranged in a specific manner to achieve a desired output and/or to configure the spacing criterium (SC). The spacing criterion (SC) for LED lighting, also known as the luminaire spacing criterion, is an estimated maximum ratio of luminaire spacing to mounting height, ensuring acceptable and uniform work-plane illuminance. In some embodiments, while achieving a desirable SC is one priority, a lighting structure 100, such as high bay fixture, also is configured for luminosity requirements. In the example depicted in FIG. 5, the light engine 530 includes twelve emitters 538, e.g., light emitting diodes (LEDs), although fewer or more emitters can be used. In some embodiments, the number of emitters, e.g., light emitting diodes (LEDs) 538, on the light engine 530 may range from 5 LEDs to 70 LEDs. In another embodiment, the number of emitters, e.g., LEDs 538, may range from 35 LEDs to 45 LEDs. It is noted that the above examples are provided for illustrative purposes only and are not intended to limit the present disclosure, as any number of LEDs may be present the printed circuit board (PCB). In some other examples, the number of emitters, e.g., LEDs 538, may be equal to 5, 10, 15, 20, 25, 30, 35, 40, 45, 50, 55, 60, 65 and 70, as well as any range of emitters, e.g., LEDs 538, with one of the aforementioned examples as a lower limit to the range, and one of the aforementioned examples as an upper limit to the range.

In some embodiments, the light engine 530 can achieve an output of approximately 18,000 lumens or more and/or an efficacy of approximately 90 lm/W or more. In some embodiments, the light engine 530 may produce an output of approximately 23,000 lumens or more and/or an efficacy of approximately 100 lm/W or more.

The emitters 538 can be arranged in a single arrangement, and/or can include two or more sub arrangements, each of which can contain any number of emitters. Circular arrangements can provide for a more omnidirectional array emission, which can increase spacing criterion (SC). Some arrangements according to the embodiments of the present disclosure can include a single ring, three or more rings, oval shaped rings, one oval ring and one circular ring, rings with polygon shapes, and so on. Many different arrangements are possible. In some embodiments, the emitters, e.g., the light emitting diodes (LEDs) 538, of the light engine 530 are mounted to a substrate that may be provided by a printed circuit board (PCB).

Some examples of solid-state light emitters 538 that are suitable for the methods and structures described herein include inorganic semiconductor light-emitting diodes (LEDs), organic light-emitting diodes (OLED), polymer light-emitting diodes (PLED) or combinations thereof. Although the following description describes an embodiment in which the solid-state light emitters are provided by light emitting diodes, any of the aforementioned solid-state light emitters may be substituted for the LEDs.

In some embodiments, the light source for the light engine 530 may be provided by a plurality of emitters, e.g., light emitting diodes (LEDs) 538, which can be mounted to a printed circuit board substrate by wire connectivity, solder, snap-fit connection, or other engagement mechanisms. In some examples, the emitters are light emitting diodes 538 that are provided by a plurality of surface mount device (SMD) light emitting diodes (LED). The circuit board for the light engine 530 may be composed of a metal core printed circuit board (MCPB). MCPCB uses a thermally conductive dielectric layer to bond circuit layer with base metal (Aluminum or Copper). In some embodiments, the MCPCB use either Al or Cu or a mixture of special alloys as the base material to conduct heat efficiently from the emitters, e.g., light emitting diodes (LEDs) 538, thereby keeping them cool to maintain high efficacy.

Referring to FIGS. 1, 2, 4, 15, 16, 18, 19 and 20, the lighting structure 100 includes a port 505 including a first retaining surface 507 and a power source interface 506, in which the port 505 is positioned to provide that the sensor 100 that is engaged thereto has access to an ambient at an exterior of the housing 501 for the lighting structure 100. The sensor 100 may include a sensor element 101 for detecting fire, detecting smoke and/or detecting noxious and/or hazardous gas. The geometry and configuration of the port 505 is selected to provide that the sensor element 101 of the sensor 100 can sample the ambient, e.g., the air, to the exterior of the housing 501. For example, the port 505 may be mounted having an opening extending through the substrate surface that the emitters of the light engine 530 are mounted too. In this example, the port 505 is present to extend through the substrate of the light engine 530 within a perimeter of the array of emitters, e.g., light emitting diodes (LEDs) 538. For example, the port 505 can be positioned to extend through the substrate of the light engine 530 so that the port 505 is positioned within a center of the array of emitters, e.g., light emitting diodes (LEDs), that provide the light source of the light engine 530.

Referring to FIGS. 1, 2, 4, 15, 16, 18, 19 and 20, the port 505 may be internally electrically connected to a power output of the driver 516 of driver electronics 515 within the housing of the lighting structure 500, thereby providing direct-current voltage power for the accessory, i.e., sensor 100. As will be further described below, the electrical interface between the lighting structure 500 and the sensor 100 can not only power the sensor 100 while it is connected to the lighting structure 50, but can also charge a rechargeable power source that is within the sensor 100, which can power the sensor 100 independent of the power output of the driver 516 of the driver electronics 500 within the lighting structure 500.

FIG. 3 illustrates one example of the driver electronics 515 within the lightings structure 500. In some embodiments, the driver electronics 515 of the lighting structure 100 are in electrical communication with the lighting structure electrical interface 502 of the housing 501. In some embodiments, the driver electronics 515 include a driver 516, a first power circuit 517 to the light engine 530, and a second power circuit 518 to the power source interface 506 of the port 505. Electrically, the lighting structure 500, and a reversibly attached sensor 100, is powered with 12VDC which is part of the LED driver. The driver electronics 515 may include: standard controls for activating and deactivating the lighting elements; lighting controls (e.g., dimmer); and/or battery back-up connections.

In some embodiments, the driver electronics 515 provides the connection point for a main power connection from the power source to the lighting structure 100. For example, the main power wire may provide to the downlight a universal input voltage, e.g., a voltage ranging from 120V to 277V. In some further examples, the main power wire may provide an input voltage of 347V. An input voltage of 120-277V can be suitable for commercial applications. In some embodiments, the input voltage can be 120V, which can be suitable for both residential and commercial applications. In addition to the main power wire, the driver electronics 515 also include a connection for dimming controls (not shown), i.e., dimming wire connection. In some embodiments, the lighting structure 500 described herein may have a diming wire that provides for 0-10V and phase dimmable applications. The driver electronics 515 may also provide power to the sensor 100. For example, from the driver 516 the driver electronics 515, a first power circuit 517 may transmit current to the light engine 530, and a second power circuit 518 may transmit current to the power source interface 506 of the port 505, which is used to power the sensor 100 when the sensor 100 is attached, e.g., reversibly attached, to the lighting structure 500.

As shown in FIG. 3, an exemplary driver 516 is schematically shown having power inputs for receiving alternating-current power (line, neutral) and power outputs (positive, negative) for providing direct-current power to the light engine 530 of the lighting structure 500. For example, the first power circuit 517 to the light engine 530 may be configured for providing direct-current power to the light engine 530, and the second power circuit 518 to the power source interface 506 of the port 505 may be configured to provide an alternating-current power for charging a rechargeable sensor power source 121 that is in the sensor 100. In yet further embodiments, the second power circuit 518 to the power source interface 506 of the port 505 may be configured to provide a direct-current power to the sensor 100.

In some embodiments, the driver 516 may include an integrated circuit chip, e.g., controller 575, acting as a microprocessor, to control the driver 516. Electrical components, such as capacitors, resistors, inductors, and so forth may be provided to configure the driver 516 to have a constant-voltage output or a constant-current output, as needed. One or more sets of auxiliary power outputs (aux) may be provided with positive and negative direct-current power outputs. The auxiliary power outputs may provide power in the range of 10-12 volts DC for external use. Electrical conductor 19 may be provided electrically connected to one of the auxiliary power outputs to convey direct-current electrical power to the socket 14. The driver 16 may be configured to respond to signals received via the auxiliary power outputs, e.g., to turn on/off the solid-state lighting fixture 12, to dim/brighten the solid-state lighting fixture 12, etc.

In some embodiments, the driver electronics 515 may further include a current mixing circuit (not shown) for controlling a mixture ratio of the at least two stings of LEDs within the light engine 530 to provide light emission of a selected lighting characteristic, such as color correlated temperature (CCT). For example, the LEDs 538 of the light engine 530 may be configured to provide different LED strings, which may each be sent a separate current level. In some examples, the mixture ratio is referring to sending different levels of current to the different LED strings. By adjusting current to each of the LED strings, the contribution of the individual light schemes color correlated temperature may be modulated to adjust the characteristics of the light emission by the combined light from the different LED strings.

In some examples, the function of the mixing circuit to control current to the different LED strings is controlled through a controller 575. The controller 575 may have additional functions than the detection of the sensor 100 being attached to the lighting structure 500. For example, upon detecting that the sensor 100 is attached to the lightings structure 500, the controller 575 can divert current through the second power circuit 518 may transmit current to the power source interface 506 either to power the sensor 100 and/or charge the rechargeable sensor power source 121, e.g., battery, that is within the housing of the sensor 100. In some embodiments, when the sensor 100 is engaged to the port 505, the battery of the sensor 100 may be charged by an alternating current. The solid-state lighting fixture 12 may be of any configuration which utilizes solid-state lighting elements for generating light, such as LEDs, OLEDs (organic light emitting diodes), and QLEDs (quantum light emitting diodes), and a driver 16 for AC/DC power conversion and control of the lighting elements. The driver 16, as is known in the art, may include auxiliary power output connections to allow for electrical output to be provided as direct current voltage in the range of 10-12 volts DC.

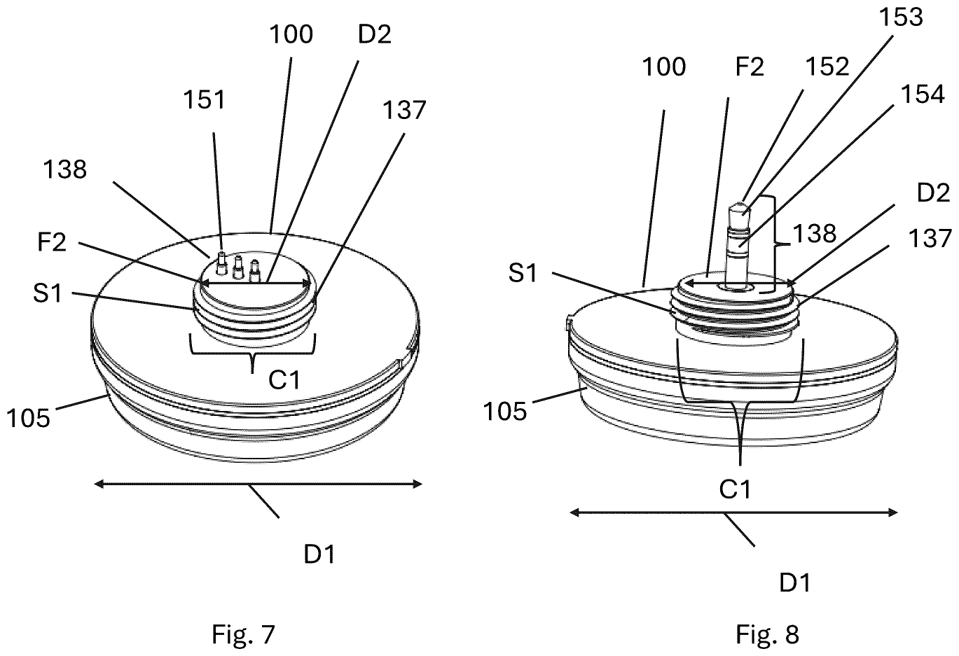

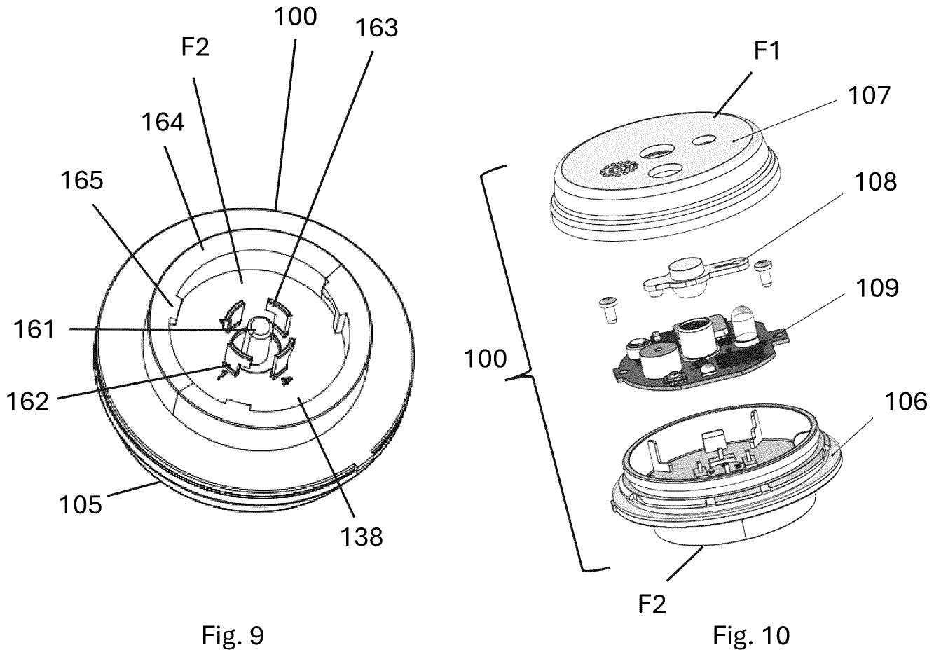

Referring to FIGS. 1-21, in some embodiments, the lighting fixture 500 and the sensor 100 are reversibly connected though the first retaining surface 507 and the power source interface 506 of the port 505 in the housing 501 of the lighting structure 500, and the second retaining surface 137 and the sensor electrical interface 138 of the sensor 100. In some embodiments, the port 505 may be referred to as a socket in the housing 501 of the lighting structure 500, in which the sensor 100 includes a plug engagement to the socket in the housing 501 of the lighting structure 500. The sensor 100 includes a sensor element 101 that provides a type for the sensor that is selected from the group consisting of dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof. The structures, systems and methods described herein allow for easy in-field mounting of accessories, e.g., sensors 100, onto installed lighting structures 500. The socket, e.g., power source interface 506 of the port 505, may be internally electrically connected to the power output of the driver 516. Various plug/socket combinations may be utilized including, but not limited to, pin and concentric electrode combinations (as depicted in FIGS. 7, 14, 15 and 16); audio plug/jack combinations (as depicted in FIGS. 8, 17, 18 and 19); and twist lock plug and socket combinations (as depicted in FIGS. 9, 20 and 21).

Advantageously, the subject invention provides for a low-cost arrangement for in-field accessory retrofitting of solid-state lighting fixtures without disassembly of the fixtures. As used herein, the term “socket” covers any opening or hollow configured to hold and electrically couple with a plug or connector. By way of non-limiting examples, a “socket” may be a jack or a port.

Referring to FIGS. 2, 4, 5, 15, 16, 18, 19 and 20, in some embodiments, the lighting structure 500 includes a port 505 (also referred to as socket) including a first retaining surface 507 and a power source interface 506, in which the port 505 is positioned for access to an ambient at an exterior of the housing 501. For example, the lighting structure 500 includes a port 505 that is configured to receive a plug, e.g., physical and electrical engagement surface of the sensor 100, that associated with one or more sensors 100, e.g., sensors 100 having sensor elements 101 for detecting hazards in the ambient in which the lighting structure 500, that can be installed in field. In some embodiments, the first retaining surface 507 includes a first thread for engagement to a second retaining surface 137 that can include a second thread on the sensor 100. In some embodiments, the first thread that is present in the port 505 of the lighting structure 500, and the second thread on the engagement surface of the sensor 100 reversibly mesh for engaging the sensor 100 to the port 505 of the lighting structure 500.

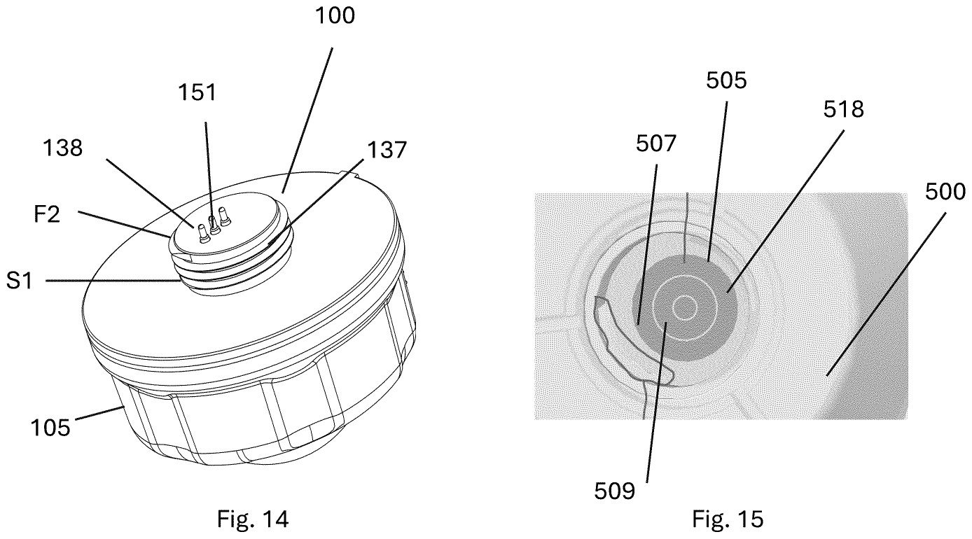

Referring to FIG. 15, in some embodiments, the power source interface 506 includes concentric electrodes 509 having a geometry for mating with pin electrodes 151 of the sensor electrical interface 138 of the sensor 100 (as depicted in FIGS. 7 and 14). In some embodiments, the concentric electrodes 509 are positioned at the base of the port 505, wherein the sidewalls of the port include the first retaining surface 507, e.g., first thread. In the embodiment depicted in FIG. 15, the concentric electrodes 509 provide for reversible electrical connection of the power source interface 506 of the lighting structure 500 to the electrodes, e.g., pin electrodes 151, of the sensor 100. In the embodiment depicted in FIG. 15, the first retaining surface 507 that includes a threaded surface provides for reversible physical engagement of the lighting structure 500 with the sensor 100.

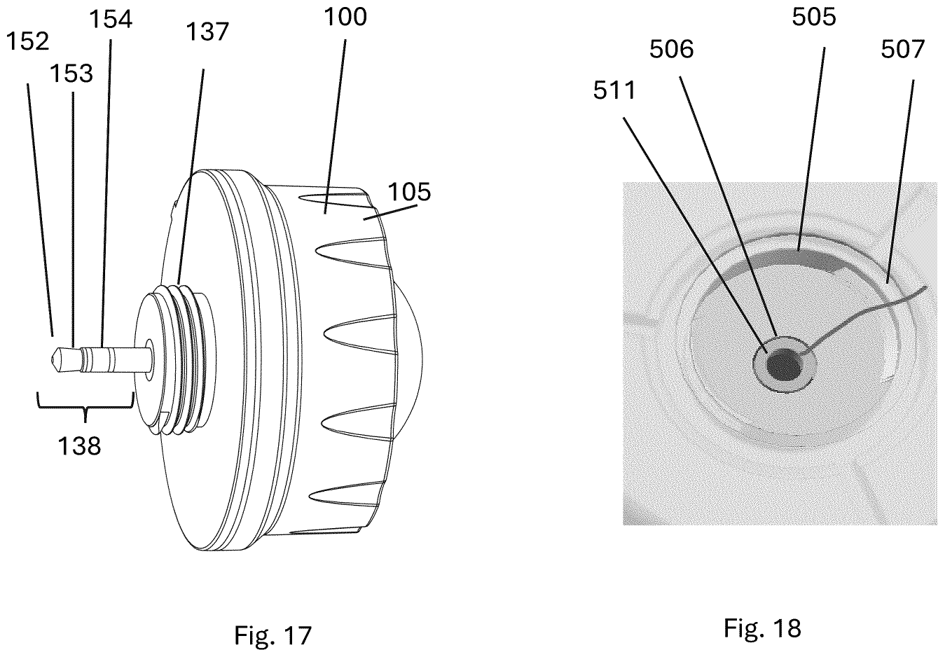

Referring to FIG. 18, in some embodiments, the power source interface 506 of the port 505 comprises a cylindrical jack 511 for receiving the male cylindrically shaped connector 152 of the sensor 100, the cylindrical jack 511 is positioned at the base of the port 505, wherein sidewalls of the port 505 include the first retaining surface 507, e.g., first thread. The cylindrical jack 511 of the port 505 may be referred to as an audio jack, e.g., a 3.5 mm audio jack port. The cylindrical jack 511 of the port 505 has dimensions for engagement a male cylindrically shaped connector 152, e.g., plug, including a tip contact 153 and at least one ring contact 154, wherein the tip contact 153 is electrically isolated from the at least one ring contact 154 (the male cylindrically shaped connector 152 is depicted in FIGS. 8 and 17).

In the embodiment depicted in FIG. 18, the cylindrical jack 511 provides for reversible electrical connection of the power source interface 506 of the lighting structure 500 to the electrode, e.g., of the sensor 100. In the embodiment depicted in FIG. 18, the first retaining surface 507 that includes a threaded surface provides for reversible physical engagement of the lighting structure 500 with the sensor 100.

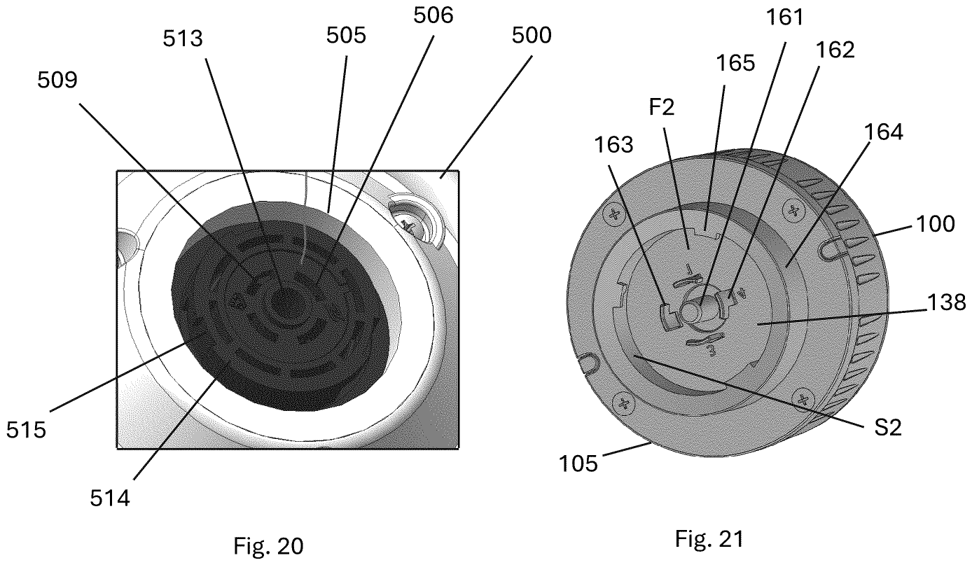

Referring to FIG. 20, in some embodiments, the structures that provide electrical communication between the sensor 100 and lighting structure 500 not only provide for electrical connection, but also provide for physical connection, e.g., reversible connection, between the sensor 100 and the lighting structure 500. For example, referring to FIG. 20, the port 505 of the lighting structure 500 may include a power source interface 506, e.g., first electrical socket engagement electrode 519. In the embodiment that is illustrated in FIG. 20, the power source interface 506 of the port 505 includes a first engagement surface that is provided by the first electrical socket engagement electrode 519. For example, the first electrical socket engagement electrode 519 of the port 505 depicted in FIGS. 9, 20 and 21 includes a laterally orientated portion for receiving the laterally orientated portion of the blade electrode for the prong portion of the electrode 162 for the sensor 100. The laterally orientated portion of the first electrical socket engagement electrode 519 may be referred to as a “latch” portion of the first electrical socket engagement electrode 519. In this embodiment, the first retaining surface 507 of the port 505 comprises a latch, and the second electrode engagement surface 163 the electrodes 162 of the sensor electrical interface 138 includes a horizontally orientated retention beam, wherein rotational movement engages the horizontally orientated retention beam into reversible locking engagement with the latch portion of the port 505 of the lighting structure 500.

In this embodiment, the socket for the port 505 depicted in FIG. 20 is configured to function in a twist and lock form of engagement with the plug, e.g., electrode 162, of the sensor 100 (see the sensor 100 depicted in FIGS. 9 and 21). In some embodiments, the electrical connection provided by the configuration of the port 505 depicted in FIG. 20 for engagement with a plug, as illustrated in FIGS. 9 and 21, may be referred to as a twist-lock connection. A twist-lock connection includes a type of locking connectors requires a twisting motion to establish and secure an electrical connection, preventing accidental disconnection.

For example, in the embodiment that is depicted in FIG. 20, the latch portion of the electrode of the socket in the port 505 of the lighting structure 500, and the horizontally orientated beam for the electrode 162 of the sensor 100 are elements of a twist lock electrode plug and socket connector, wherein the horizontally orientated beam (second electrode engagement surface 163) is an end portion of an electrode 162 from the sensor electrical interface 138 that engages the power source interface 506 of the port 505 in the lighting structure 500.

In the embodiment depicted in FIGS. 9, 20 and 21, the receiving electrodes are internally positioned within the port 505 and provides for reversible electrical connection of the power source interface 506 of the lighting structure 500 to the electrodes 162 of the sensor 100, which may be provided by blade electrodes. However, the receiving electrodes, e.g., first electrical socket engagement electrode 519, of the port 505 in this embodiment also function as the first engagement surface for physically connecting the sensor 100 and the lighting fixture 500. Referring to FIG. 20, the receiving electrodes, e.g., first electrical socket engagement electrode 519, of the port 505 for the lighting structure 500 and the electrodes 162 of the plug for the sensor 100 may not be the only mechanism by which the lighting fixture 500 and the sensor 100 are physically engaged to one another, i.e., reversibly engaged to one another.

For example, the port 505 may further include a collar 514 including one or more retaining slot 575 for engaging a retaining tab 165 that is an element of the sensor 100. The one or more retaining slot 575 of the collar 514 and the retaining tab 165 of the sensor 100 provide an additional mechanism by which the lighting fixture 500 and the sensor 100 may be physically connected to one another in a reversible manner.

The collar 514 may be a circular pedestal that extends from the base of the housing 501 of the lighting structure, wherein the circular pedestal includes the one or more retaining slot 575 on an exterior sidewall. The circular pedestal may be configured to extend around a perimeter of the socket including the electrode of the power source interface 506 of the lighting structure 500 to the sensor 100. In some embodiments, the one or more retaining slot 575 further includes a groove that is formed in the exterior sidewall of the circular pedestal that at least partially extends around a perimeter of the circular pedestal. The grooves may extend from the one or more retaining slots 575 and functions to engage the retaining tab 165 of the sensor 100. It is noted that in the embodiment depicted in FIG. 20, the port 505 of the lighting fixture 500 is configured for positioning the sensor 100 for measuring an ambient from an exterior of the housing 501 of the lighting structure 500.

Referring to FIGS. 1-21, in some embodiments, the sensor 100 for reversible engagement to the port 505 of the lighting structure 500 may include a sensor element 101 for reading elements from the ambient that is exterior to the lighting structure 500. Each of the embodiments for the sensor 100 include an interface that provides for reversible engagement of the sensor 100 to the port 505 of the lighting structure. The reversible engagement includes both a reversible electrical contact, i.e., a mating of electrical circuitry through a reversible connection of the port 505 and the sensor 100, and a reversible physical contact, i.e., a reversible physical connection holding the sensor 100 together with the lighting structure in an assembly of two separate structures. In some embodiments, the elements of the sensor 100 that provide for reversible engagement to the lighting structure 500 include a second retaining surface 137. The second retaining surface 137 may be configured to reversibly couple with the first retaining surface 507 in the port 505 of the lighting structure 500. The sensor 100 further includes a sensor electrical interface 138 to reversibly mate with the power source interface 506 in the port 505 of the lighting structure 500.

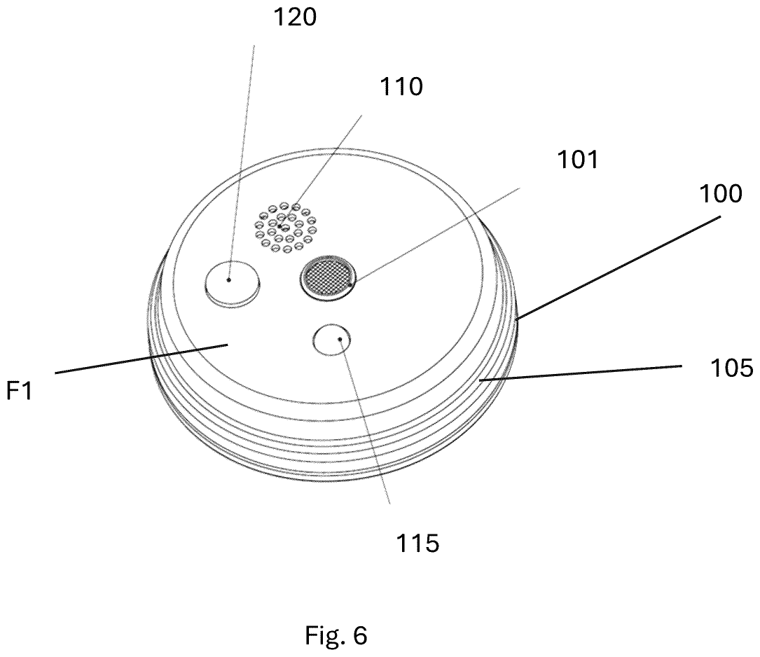

Referring to FIG. 6, in some embodiments, the sensor 100 may include a sensor body 105 (also referred to as a sensor housing) that houses the sensor element 101. The element of the sensor body 105 may be constructed to conform with an enclosure rating. For example, enclosure ratings, including, IP66 can be provided for the construction of the sensor body 105, such as IP66. It is noted that IP66 is only one example of an enclosure rating that the sensor body 105 can be constructed to conform with. Other such enclosure standards that are available or may become available can be suitable for the construction of the sensor 105.

The sensor body 105 may include a first face F1 including a sample collection surface for the sensor element 101, and a second face F2 including the sensor electrical interface 138. In some embodiments, the sensor body 105 also includes a sidewall S1 between the first face F1 and the second face F2. As will be described below, in some embodiments, the second thread that provides the second retaining surface 137 for engagement with the first thread that provides the first retaining surface 507 is present on the sidewall S1 of the sensor body 105 that extends from the second face F2 including the sensor electrical interface 138. Similar to the housing 501 of the lighting structure 500, the sensor body 105 may be composed of a rigid material, e.g., a metal or polymeric material (e.g., plastic).

Other elements of the sensor 100 can also include an alarm speaker 110, remote infrared (IR) receiver 114 and optical window 120. In some embodiments, the sensor element 101 may detect smoke, harmful gases or flammable gases, environmental parameters. In some embodiments, the remote infrared (IR) receiver 114 may receive infrared control signals. The control signals may provide programming, instructions, data transfer to and from the sensor 100. In some embodiments, the optical window 120 is a transparent structure that allows for light transmission to show a sensor status signal. For example, when the alarm is triggered by the alarm device, light may be emitted through the optical window 120 to communicate a visual alarm, i.e., a visual alarm signal. In some embodiments, when the sensor 100 issues an alarm responsive to measurements taken by the sensor element 101, the alarm speaker 110 can trigger an audible alarm. For example, when an alarm is triggered in response to the sensor element 101 detecting a hazard from the ambient that is exterior to the lighting structure 500, the alarm speaker 110 can emit a sound to designate an alarm is being broadcast, e.g., a shrill siren alarm sound.

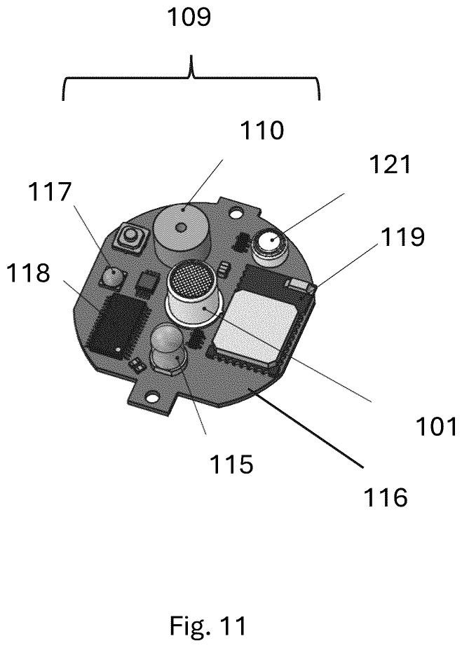

FIG. 10 is an exploded view for the sensor 100 illustrating some elements of the sensor's 100 internal structure. For example, the sensor body 105 may be a two-piece housing that include a base portion 106 and a cover portion 107. The base portion 106 and the cover portion 107 of the sensor body 105 may be mated to one another to house a sensor circuit board assembly 109. The sensor circuit board assembly 109 is a component of the sensor 100 for providing the alarm function. The cover portion 107 may include openings corresponding to the alarm speaker 110, the remote infrared (IR) receiver 114 and optical window 120. In some embodiments, a light guide 108 may be present between the light emitting visual alarm 117 (depicted in FIG. 11) and the optical window 120. The light guide 108 may also function as a button to be pressed by a person for terminating an alarm that has been emitted by the sensor 100. In this embodiment, the light guide 108 includes a button portion that extends through the cover portion 107 of the sensor body 105, and an actuator portion that actuates a switch on the sensor circuit board assembly 109 for cancelling an alarm. For example, when alarm occurs, e.g., an alarm sound emitted by the alarm speaker 110 and/or a light emitted by the light emitting visual alarm 117, the alarm may be cancelled by pressing the “Light-Guide” button.

FIG. 11 illustrates one embodiment of the sensor circuit board assembly 109 that includes a printed circuit board (PCB) substrate 116, the sensing element 101, an audible alarm speaker 110, a light emitting visual alarm 117, a smart module 119, a processing unit (microprocessor unit (MCU) 118), and a rechargeable sensor power source 121. In some embodiments, the sensing element 101 may be for detecting smoke, or for detecting fire, harmful gases, flammable gases, or environmental parameters.

In some embodiments, the audible alarm speaker 110 may be provided by a buzzer. In some examples, when the sensor 100 emits an alarm signal, the buzzer emits a shrill sound. For example, when the sensing element 101 detects a hazard from the ambient from the environment that is exterior to the housing 501 of the lighting structure 500, the audible alarm speaker 110 may turn on to emit sound through speaker holes in the cover portion 107 of the body 105 of the sensor 100 to signal hazard detection to individuals in the room where the assembly of the sensor 100 and the lighting structure 500 is positioned. The audible alarm speaker 110 can also provide a sound signal indicating the status of the sensor 100. For example, if the sensor 100 has failed, it can emit a sound indicating a malfunction. For example, if the sensor 100 is no longer being powered by power from the lighting structure 500, e.g., if the sensor 100 is solely being powered by its independent power source, e.g. the rechargeable sensor power source 121, the audible alarm speaker 110 can emit a sound indicating that the sensor 100 is being powered by the rechargeable sensor power source 121. The sound emitted by the audible alarm speaker 110 for indicating the presence of a hazard detected by the sensing element 101 of the sensor can be different from the sounds emitted by the audible alarm speaker 110 for indicating a malfunction of the sensor 100 or the sounds emitted by the audible alarm speaker 110 for indicating that the sensor 100 is only being powered by the rechargeable sensor power source 121.

In some embodiments, the sensor circuit board assembly 109 can further include a light emitting visual alarm 117 corresponding to the optical window 120. The light emitting visual alarm 117 can include a light emitting diode (LED). The light emitting visual alarm 117 is separate from the light engine 530 of the lighting structure 500. The light emitting diode (LED) can display the working status information of the sensor 100 and can also send out optical alarm signals. For example, when the sensing element 101 detects a hazard from the ambient from the environment that is exterior to the housing 501 of the lighting structure 500, the light emitting diode (LED) of the light emitting visual alarm 117 may turn on to emit light, it may change color, and/or it may flash light intermittently to signal hazard detection. The light is transmitted from the light emitting visual alarm 117 through the light guide 108 and through the optical window 120 where it may be observed by individuals in the room where the assembly of the sensor 100 and the lighting structure 500 is positioned.

The light emitting visual alarm 117 can also provide a light signal indicating the status of the sensor 100. For example, if the sensor 100 has failed, it can emit a light signal indicating a malfunction. For example, if the sensor 100 is no longer being powered by power from the lighting structure 500, e.g., if the sensor 100 is solely being powered by its independent power source, e.g., the rechargeable sensor power source 121, the light emitting visual alarm 117 can emit a light signal indicating that the sensor is being powered by the rechargeable sensor power source 121. The light emitted by the light emitting visual alarm 117 for indicating the presence of a hazard detected by the sensing element 101 of the sensor 100 can be different from the light emitted by the light emitting visual alarm 117 for indicating a malfunction of the sensor 100, or the light signal emitted by the light emitting visual alarm 117 for indicating that the sensor 100 is only being powered by the rechargeable sensor power source 121. The difference in colors for indicating a hazard alarm or a sensor operational state can be difference in colors, light brightness, flashing rate of the light, etc.

In some embodiments, the sensor circuit board assembly 109 can further include a smart module 119. A “smart module” is a integrated piece of hardware that combines multiple functions, like computing, connectivity, and graphics processing, into a single unit. In one example, the smart module 119 includes a processor similar to the microcontroller unit (MCU) 118. Therefore, the description of the MCU 118 can provide some embodiments for the processor elements of the smart module 119 for computing. In addition to the processor the smart module 119 can also include memory including programming instructions for causing the processor elements of the smart module 119 to send alarm communications wirelessly. The alarm communications may be when the sensor element 101 detects a hazard in the ambient that is exterior to the housing 501 of the lighting structure 500, or alarm communications indicating the status of the sensor 100, such as the occurrence of a malfunction in the sensor 100 and/or change in power status for powering the sensor 100.

The smart module 119 can send Wi-Fi signals using an antenna to transmit and receive data. In some embodiments, the smart module 119 can communicate with a host device (like the MCU 118) via a control interface (e.g., a serial port) to receive commands and send data. In some embodiments, the smart module 110 uses a control interface (e.g., serial port) to communicate with a user device (not shown), allowing the user device to send commands and receive data. In some embodiments, the smart module 119 uses a Wi-Fi network to transmit data to and from a remote server or another device on the same network. In some embodiments, the smart module 119 can use a TCP/IP protocol stack for reliable data transmission over a Wi-Fi network. In some embodiments, WiFi component may be an ESP8266 module with an integrated TCP/IP protocol stack, enabling microcontrollers to connect to Wi-Fi network. In some embodiments, the WiFi component may be able to control the sensor through the IR transceiver 115 that is also a component of the sensor circuit assembly 109. In this example, the WiFi component of the smart module 119 can receive WiFi commands and then translate them into IR signals to control the sensor 100, send signals to the sensor 100 and/or receive signals at the sensor 100 through the IR transceiver 115. In this example, a smart module 119, such as an ESP8266 or similar microcontroller with WiFi capabilities, can be programmed to act as an intermediary.

In some embodiments, the smart module 119 can be included on the sensor circuit board assembly 109 when it is desired for the sensor 100 to send alarm signals wirelessly to a user device, such as mobile computing device which can receive a wireless or internet connection type signal. In some embodiments, the smart module 119 can be included on the sensor circuit board assembly 109 to connect to an intelligent system of lamps or other intelligent systems. For example, if one sensor 100 that is connected to a lighting structure 500 detects a hazard, it can transmit its signal to every other sensor 100 in the network, and the network of sensors 100 can all transmit alarm communications using the alarm sirens 110 or the light emitting visual alarm 117 to signal the detection of a hazard throughout the network of sensors 100.

For example, the communications element of the smart module 119 may be a wireless control module that is based on IEEE 802.11, which stands for wireless LANs (WLANs), also known as Wi-Fi. The smart module 119 may employ a WiFi transmitter to access the internet. The WIFI wireless signal can be based upon IEEE 802.11, which is for wireless LANs (WLANs), also known as Wi-Fi. 802.11 is a family of specifications for wireless local area networks (WLANs) developed and maintained by a working group of the Institute of Electrical and Electronics Engineers (IEEE). The 802.11 is a wireless networking standard having technical specifications that govern the implementation of Wi-Fi networks for device compatibility and connectivity. Built into the 802.11 specification family are best practices, physical hardware-layer requirements and algorithms to address resource contention on shared networks. 802.11 specifies the interface that enables over-the-air signaling between two or more wireless clients, e.g., between two sensors 100 including smart modules 118 in a network and/or between the sensor 100 and a user device. Each version of 802.11 spells out a theoretical performance limit, such as data throughput, signal range, network bandwidth and radio frequencies.

The earliest 802.11 iterations focused on improving speeds and data rates. The initial 802.11 spec specified operations in the 2.4 gigahertz (GHz) ISM band, with a top speed of about 2 megabits per second (Mbps), well below the gigabit-level data rates of a modern WLAN. With each technological advance, the amended specification has been identified by adding a suffix of one or two letters to the 802.11 nomenclature. Over time, the string of letters and numbers created confusion for enterprises trying to evaluate the capabilities of vendor products.

WLAN channels rely on networking equipment engineered for high performance. 802.11 deploys six half-duplex, over-the-air modulation techniques that share the same network protocol layer. 802.11 makes several radio frequencies that Wi-Fi devices use to communicate, including the 900-megahertz, 2.4 GHz, 3.6 GHz, 4.9 GHz, 5 GHz, 5.9 GHz, 6 GHz and 60 GHz bands. Each frequency can be subdivided into multiple channels.

The original modulation used in 802.11 was binary amplitude-shift keying, binary frequency-shift keying, binary phase-shift keying and other schemes, such as complementary code keying. Those methods were simpler with regard to designing circuits, but they provided a limited bit rate. Newer modulation methods have emerged that provide higher data speed and reduce a network's vulnerability to interference.

Orthogonal frequency-division multiplexing (OFDM) has gained increasing prominence since the launch of 802.11a, as it expands the number of clients that can connect to a shared wireless access point. OFDM may be used in tandem with other modulation techniques, such as quadrature amplitude modulation (QAM).

802.11 specifies the use of carrier sense multiple access/collision avoidance, an algorithm that manages path sharing between two transmitting stations. The methodology is similar to IEEE's 802.3 standard for Ethernet networks, although it differs in implementation. Ethernet uses a full-duplex model for collision avoidance, where the network can listen and talk to devices at the same time. To prevent signals from colliding, Ethernet only allows a signal to be sent once acknowledgement is received that the transmission line is clear. By contrast, a Wi-Fi network uses a half-duplex model, where it can listen or speak but not do both simultaneously. Wi-Fi uses a media access protocol known as the distributed coordination function (DCF) to monitor signal traffic. If a client on the receiving end doesn't acknowledge a transmission, DCF presumes a collision has occurred and waits for a given amount of time before attempting to retransmit the wireless signal.

Specific examples of IEEE 802.11 specification signal communication that can be used to send the communication signal from the messaging device may include the following:
a) 802.11 is a technology specified into two spread-spectrum methods in the 2.4 GHz band: frequency hopping and direct sequence, each at 1 Mbps or 2 Mbps, along with diffuse infrared at 1 Mbps.
b) 802.11b boosted speed to 11 Mbps using direct sequence spread spectrum (DSSS) in 2.4 GHz. It also accommodated weak signals by maintaining lower DSSS modes and emerged as the signature WLAN technology.
c) 802.11a uses an OFDM physical layer in the 5 GHz band to transmit up to 54 Mbps. The advantage of 5 GHz is it's less crowded, but the higher frequency can limit its effective signal range.
d) 802.11g uses OFDM in the 2.4 GHz band to achieve similar 54 Mbps transmission, excluding forward error correction. However, this approach also is subject to signal interference from nearby devices. 802.11g and 802.11b equipment are compatible, and vendor equipment carries both designations.
e) 802.11n, also referred to as Wi-Fi 4, marked the start of new Wi-Fi standards branding. All 802.11n wireless products support multiple input, multiple output (MIMO) technology, in which multiple transmitters and receivers are used to transfer more data at the same time. The addition of multiple antennas boosts the theoretical data rate to 450 Mbps in 2.4 GHz operation. 802.11n reportedly is backward-compatible with 802.11a, 11b and 11g networks.
f) 802.11ac, also known as Wi-Fi 5, pivots off amendments to 802.11n. Maximum data rates reach the gigabyte level in 5 GHz operation, with expanded channel width, twice the number of spatial streams, 256 QAM bandwidth increases and enhanced multiuser MIMO.
g) 802.11af enables WLAN operation in very high frequency and ultra-high frequency bands normally reserved for TV broadcast signals.
h) 802.11ah describes WLANs with low power consumption that could power extended-range hotspots or serve to handle traffic overloads on a cellular network. 802.11ah-enabled WLANs can provide an alternative to short-range Bluetooth connectivity.
i) 802.11aj, also called the Chinese Millimeter Wave frequency band, is for WLANs in China and other regions. It provides backward compatibility with 802.11ad, which is in review.
j) 802.11ax, also known as Wi-Fi 6, uses the 2.4 GHz and 5 GHz frequency bands but has the option to use 6 GHz.
k) 802.11be, also known as Wi-Fi 7, provides speeds of up to 46 gigabits per second (Gbps). Quadrature Amplitude Modulation (QAM) is a method to transmit and receive data in radio-frequency waves. The higher it is, the more information you can pack in. Wi-Fi 7 supports 4K-QAM, while Wi-Fi 6 supported 1,024-QAM, and Wi-Fi 5 was limited to 256-QAM.

It is noted that the above standards are provided for illustrative purposes only. The smart module 119 can use these radio standards to transmit communications signals that indicate that the sensor 100 has detected a fire event. The smart module 119 may transmit a WiFi signal to be received by a router that is connected to the internet for the purposes of transmitting a signal that the sensor 100 has detected a hazard event or has diagnostic type information to send to a user.

It is not necessary that the smart module 119 communicate using WiFi. In some other embodiments, the smart module 119 include a Bluetooth (BLE) circuit. The smart module 119 may also use a cellular network to transmit signal. In this example, the messaging device of the smart module 119 can access the internet wirelessly by providing a signal to a user that a hazard, e.g., fire, has been detected or there has been a change in status of the sensor 100 that the user should be made aware of. Using cellular data, the messaging device of the smart module 119 can access the internet wirelessly through a cellular network, allowing it to connect to the web even when not connected to a Wi-Fi network, typically using a mobile phone carrier's signal via cell towers to send and receive data.

In some embodiments, the messaging device of the smart module 119 that relies upon cellular data may rely upon a signal standard, such as GSM, CDMA, UMTS (3G), LTE (4G), and 5G. CDMA (Code Division Multiple Access) uses a unique code for each user to separate signals, allowing multiple users to share the same frequency band simultaneously. GSM (Global System for Mobile Communications) employs time division multiple access (TDMA) where users take turns transmitting data within a designated time slot on a shared frequency. 2G (Second Generation) is primarily for voice calls with basic data capabilities, often using GSM or CDMA standards. The 3G (Third Generation) standard introduced faster data speeds, enabling better mobile internet browsing and streaming. The 4G (Fourth Generation) standard provides a significant improvement in data speed with (Long Term Evolution) that enable faster downloads and streaming. The 5G (Fifth Generation) standard provides further increased speeds, lower latency, and the ability to support more connected devices. The smart module 119 can also rely upon Bluetooth or Bluetooth Low Energy (BLE) to provide wireless signal transmission. Bluetooth Low Energy (BLE) is generally combined with classic Bluetooth.

Zigbee technologies and similar standards based on the IEEE 802 network standard can be used for the sending wireless signals with the smart module 119. ZigBee can be an extension of the 802.15.4 standard.

In some embodiments, the smart module 119 can employ Z-wave. Z-Wave works by using mesh networking and low-energy radio waves to create a network of devices that can exchange information with each other. More particularly, each device in a Z-Wave network functions as a mini-router, relaying information to the next closest device until it reaches the central hub. This allows the network to extend its range without the need for repeaters or modems. Z-Wave uses a specific, low frequency (908.42 MHz in the US and Canada) that allows devices to consume less power. Z-Wave devices can exchange control commands and data with each other. For example, signal can be sent to a Z-wave messaging device from a smartphone, tablet, computer, wireless key fob, or wall-mounted panel.

As noted above, the smart module 119 can send an alarm message wirelessly to a user device. The user may read the alarm message from device that can be provided by a mobile computing device, a laptop/notebook computer, a subnotebook, a tablet, a phablet computer, a mobile phone, a smartphone, a personal digital assistant (PDA), a portable media player (PMP), a mobile phone, handheld gaming device, gaming platform, portable computing device, body-worn computing device, smart watch, smart glasses, smart headgear, or a combination thereof.

In some embodiments, the smart module 119 is an optional component, and can be omitted from the sensor 100.

In some embodiment, the sensor circuit board assembly 109 for the sensor 100 may further include a microcontroller unit (MCU) 118. A microcontroller unit (MCU) 118 is a small computer on a single integrated circuit. The microcontroller 118 may contain one or more CPUs (processor cores) along with memory and programmable input/output peripherals. Program memory in the form of NOR flash, OTP ROM, or ferroelectric RAM is also often included on the chip, as well as a small amount of RAM. The MCU 118 is a component for signal processing and control. The MCU 118 controls the overall operation and functionality of sensor 100.

In some embodiments, the MCU 118 functions by executing the program instructions stored in its non-volatile memory module. The MCU may have memory that is ROM-based. In some embodiments, the MCU can store program instructions using built-in flash memory. In some embodiments, the MCU can use RISC (Reduced Instruction Set Computer) instruction architecture for its fundamental instruction processing. To develop the program for the MCU, embedded system developers use an assembler or C programming language. When powered up, the MCU starts executing the instruction loaded as program data. It can utilize the RAM to store run-time variables as indicated by the program.

The program can include a number of instructions. For example, the program can include instructions for actuates at least one of the audible alarm speaker 110, the light emitting visual alarm 117 and/or smart module 119 for sending wireless alarm communications in response to a hazard being detected by the sensor element 101 of the sensor 100. For example, the program can include instructions for actuating at least one of the audible alarm speaker 110, the light emitting visual alarm 117 and/or smart module 119 for sending wireless alarm communications in response to a hazard being detected by the sensor element 101 of the sensor 100. For example, the program can include instructions for actuating at least one of the audible alarm speaker 110, the light emitting visual alarm 117 and/or smart module 119 for sending wireless alarm communications in response to a malfunction of the sensor 100 that will require servicing. For example, the program can include instructions for actuating at least one of the audible alarm speaker 110, the light emitting visual alarm 117 and/or smart module 119 for sending wireless alarm communications in response to change in the power source for powering the sensor 100, e.g., the occurrence of a power outage from the lighting structure 100, and power to the sensor 100 solely being provided by the rechargeable sensor power source 121.

As noted, in some embodiments, the sensor circuit board assembly 109 also includes an IR (infrared) transceiver 115. The IR transceiver 115 is a device that detects and decodes infrared light signals or other IR sources, allowing devices to receive commands wirelessly. In some examples, one main component is a photodiode or phototransistor, which converts the received infrared light into an electrical signal.

In some embodiments, the sensor circuit board assembly 109 also includes a rechargeable sensor power source 121. The rechargeable sensor power source 121 may be a battery. For example, the battery for the rechargeable sensor power source 121 may be a Nickel-metal hydride (NiMH) rechargeable battery. In other example, the rechargeable sensor power source 121 may be a lithium ion based battery. In some embodiments, the rechargeable sensor power source 121 provides that when power is not being supplied to the lighting structure 500, e.g., the lighting structure 500 is turned off, powering is continuously provided to the sensor 100 to continuously ensure its operation without power interruption. In some embodiments, the rechargeable sensor power source 121 in electrical communication with the second power circuit 518 of the driver electronics 515 in the lighting structure 500 thorough the power source interface 506 of the port 505 in the lighting structure 500. When the rechargeable sensor power source 121 is not powering the sensor 100 it may be charged by driver electronics 515 in the lighting structure 500 thorough the power source interface 506 of the port 505 in the lighting structure 500. For example, when the light is turned on, e.g., the light engine 530 of the lighting structure 500 is emitting light, the rechargeable sensor power source 121, e.g., battery, will be charged. For example, when the power to the light is off, e.g., the light engine 530 of the lighting structure 500 is not emitting light, the rechargeable sensor power source 121, e.g., battery, will continue to support the sensing operation, e.g., power the sensor 100 to continue to analyze the ambient using the sensing element 101 and issue alarms. The rechargeable sensor power source 121, e.g., battery, can last for weeks or even months once the battery is fully charged.

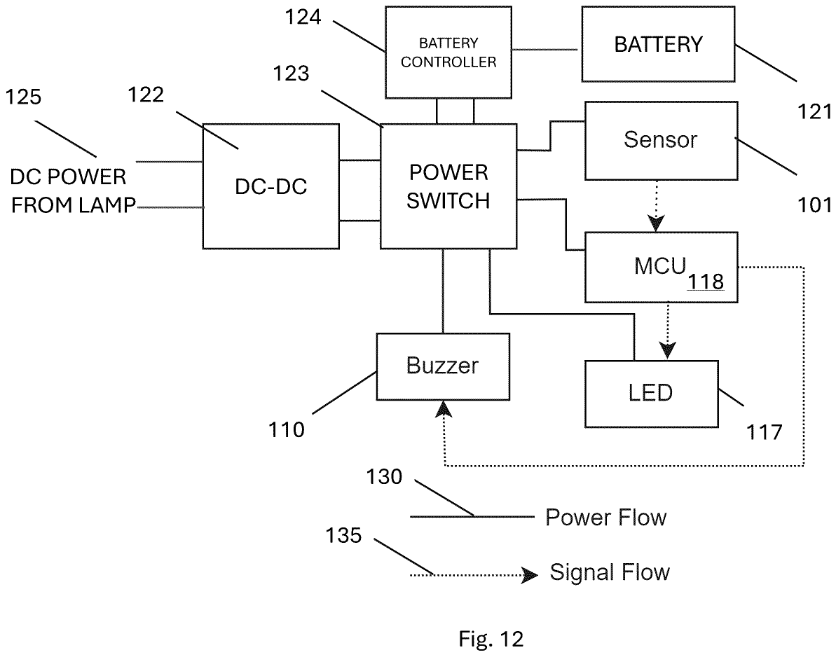

FIG. 12 is a circuit diagram of the driver electronics of the sensor 100 including a rechargeable sensor power source 121 and a microcontroller unit (MCU) 118. When the sensor 100 is not integrated with a smart module 119, the sensor 100 only needs to get power supply from the driver electronics 515 of lighting structure 500 through the power source interface 506 within the port 505 to keep the sensor 100 continuously working. As illustrated in FIG. 12, DC power from the lighting structure 500 extends through the driver 516 of the driver electronics 515 for the lighting structure 500 through a second power circuit 518 to the power source interface 506 of the port 505 in the housing 501 of the lighting structure 500.

From the power source interface 506 of the port 505, the DC power 125 passes to a DC-DC converter 122 of the driver electronics of the sensor 100. A DC-to-DC converter is an electronic circuit that efficiently converts a direct current (DC) voltage from one level to another, either stepping it up or down, and can also regulate the output voltage. From the DC-DC converter 122, the power reaches a power switch 123 that is controlled by a controller 124 connected to the rechargeable sensor power source 121.

As noted above, when the lighting structure 500 is powered, e.g., the lighting structure 500 is ON, the controller 124 actuates the power switch 123 so that the sensor 100 is powered by the DC power from the lighting structure 500. Powering the sensor 100 means that current from the DC power from the lighting structure 500 is passed to the sensor element 101, the audible alarm speaker 110, the light emitting visual alarm 117 and the microcontroller unit (MCU) 118. The power flow is identified by reference number 130. Further, when the lighting structure 500 is powered, e.g., the lighting structure 500 is ON, the controller 124 actuates the power switch 123 so that the rechargeable sensor power source 121 is charged by the DC power from the lighting structure 500. In some embodiments, when the lighting structure 500 is not powered, e.g., the lighting structure 500 is OFF, the controller 124 actuates the power switch 123 so that the rechargeable sensor power source 121 is powering the sensor 100. Signal flow between the sensor element 101, the microcontroller unit (MCU) 118, the audible alarm speaker 110, and the light emitting visual alarm 117 is identified by reference number 135.

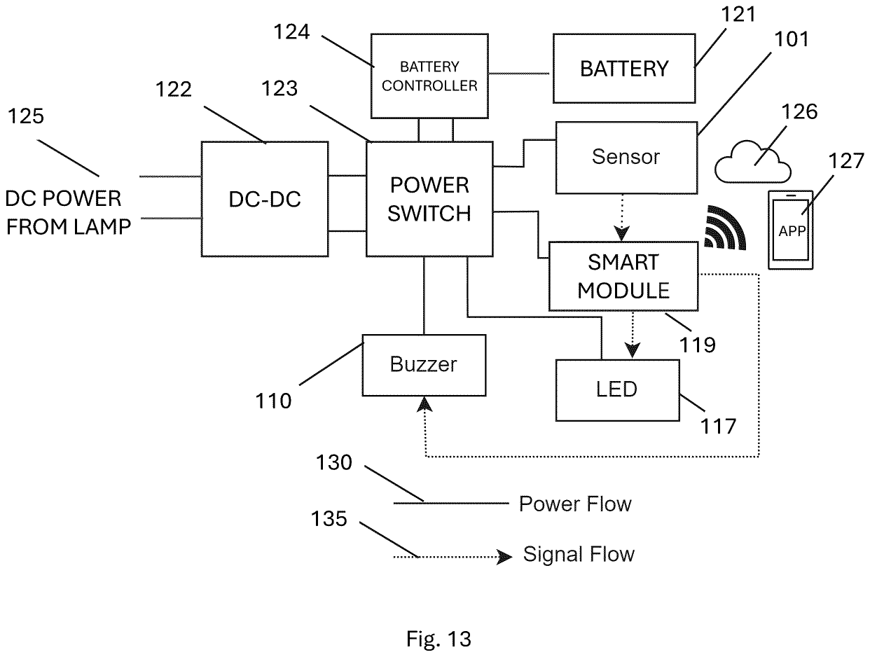

FIG. 13 is a circuit diagram of the driver electronics of the sensor 100 including a rechargeable sensor power source 121 and a smart module 119. When the sensor 100 is not integrated with a smart module, it only needs to get power supply from the driver electronics 515 of lighting structure 500 through the electrical interface to keep the sensor 100 continuously working. As illustrated in FIG. 12, DC power from the lighting structure 500 extends through the driver 516 of the driver electronics 515 for the lighting structure 500 through a second power circuit 518 to the power source interface 506 of the port 505 in the housing 501 of the lighting structure 500. From the power source interface 506 of the port 505, the DC power 125 passes to a DC-DC converter 122 of the driver electronics of the sensor 100. A DC-to-DC converter is an electronic circuit that efficiently converts a direct current (DC) voltage from one level to another, either stepping it up or down, and can also regulate the output voltage. From the DC-DC converter 122, the power reaches a power switch 123 that is controlled by a controller 124 connected to the rechargeable sensor power source 121.

As noted above, when the lighting structure 500 is powered, e.g., the lighting structure 500 is ON, the controller 124 actuates the power switch 123 so that the sensor 100 is powered by the DC power from the lighting structure 500. Powering the sensor 100 means that current from the DC power from the lighting structure 500 is passed to the sensor element 101, the audible alarm speaker 110, the light emitting visual alarm 117 and the smart module 119. The power flow is identified by reference number 130. Further, when the lighting structure 500 is powered, e.g., the lighting structure 500 is ON, the controller 124 actuates the power switch 123 so that the rechargeable sensor power source 121 is charged by the DC power from the lighting structure 500. In some embodiments, when the lighting structure 500 is not powered, e.g., the lighting structure 500 is OFF, the controller 124 actuates the power switch 123 so that the rechargeable sensor power source 121 is powering the sensor 100. Signal flow between the sensor element 101, the smart module 119, the audible alarm speaker 110, and the light emitting visual alarm 117 is identified by reference number 135.

Referring to FIG. 13, in some embodiments, the smart module 119 provides wireless signal for communicating data from the sensor 100, such as whether a hazard has been detected by the sensing element 101, the sensor functionality, and/or the sensors power state, to the internet 126 to be received by a user device 127, e.g., mobile computing device, such as a laptop computer, tablet computer, smart phone, and/or terminal specific to the sensor 100. Referring to FIG. 13, in some embodiments, the smart module 119 provides wireless signal for receiving data at the sensor 100, such as control commands, sent through the internet 126 from a user device 127, e.g., mobile computing device, such as a laptop computer, tablet computer, smart phone, and/or terminal specific to the sensor 100.

Referring to FIGS. 1 and 6-13, a number of different sensor elements 101 may be employed in the sensors 100 for reversible engagement to the lighting structure 500. In some embodiments, the sensor element 101 of the sensor 100 is for detecting fire and/or smoke. Examples of fire or smoke detection sensors, e.g., sensor elements 101, that suitable for use with the sensor 100 integrated into the lighting structures 500 of the present disclose can include dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, and temperature sensors (e.g., negative temperature coefficient sensors).

In some embodiments, the sensor 100 may be a smoke detector. Smoke detectors use an optical or electrochemical sensor to detect smoke. The smoke detector may be an optical smoke detector, a photoelectric smoke detector and/or an ionic smoke detector.

An optical smoke detector is a device that detects smoke generated in a fire and is drawn into the detector. An optical smoke detector may employ a sensor element 101 that includes light-emitting diodes (LEDs) to illuminate the surrounding area of a smoke chamber detector for analysis. The LEDs of the sensor element 101 for the optical smoke detector are connected to a photodetector, typically a photodiode array or a single photodiode. The photodiode converts the reflected light into electricity, and the generated voltage is used to determine if there is smoke in the protected location.

Photoelectric smoke detectors also use sensor elements 101 that employ light to detect smoke, but respond faster than optical detectors. Photoelectric smoke detectors employ sensor elements 101 that can include optical cameras to detect smoke. In some embodiments, the speed by which photoelectric smoke detectors react makes them ideal for areas where protection against fires that are expected to grow rapidly is needed, such as in kitchens.

Ionic (or ionization) smoke detectors are similar to photoelectric devices in that they respond quickly without relying on a complicated scanning mechanism. However, the sensing elements 101 of ionic smoke detectors work by measuring ion levels in the surrounding air, not visible light as is analyzed in photoelectric smoke detectors or optical smoke detectors. This means that ionic detectors of the sensing elements 101 for the sensor 100 tend to be more effective for detecting fires where a large amount of smoke is not expected. Ionic smoke detectors may be suitable for use in chemical environments.

In some embodiments, the sensor 100 for detecting fire may be including a sensing element 101 that is a temperature detector. Examples of temperature detectors that can be used for the sensor element 101 integrated into the housing 50 of the lighting structure may include thermal detectors and thermovelocimetric detectors.

Thermal detectors may be used to detect high temperatures, activating an alarm signal once the predefined temperature threshold has been exceeded. In some embodiments, thermal detectors can employ a sensor element that includes platinum resistance thermometers (PRTs) or thermocouples, which detect temperature changes in a wire. Thermal detectors can be suitable for use in locations where high temperatures occur during normal activity or where there are sudden increases in temperature, such as in manufacturing environments employing ovens or kitchens.

Thermovelocimetric (TV) fire detectors are a type of smoke detector that uses a thermistor as the sensor element to detect a temperature rise that would signal that a fire has started. A thermistor is a semiconductor device whose electrical resistance varies with temperature. In some embodiments of thermovelocimetric (TV) fire detectors, a thermistor is placed in a stream of air and connected to an electronic circuit. The electronic circuit measures changes in voltage as the temperature of the air increases. When smoke enters the air stream, it absorbs heat and lowers its temperature. This causes a change in voltage measured by the thermovelocimeter detector circuit, which may activate a fire detection signal.

In some embodiments, the sensor element 101 for detecting fire may be a flame detector. Examples of flame detectors that can be employed for the sensor 100 may include infrared flame detectors, ultraviolet flame detectors and flame detectors including combined infrared flame detecting elements and ultraviolet detecting elements. The flame detectors can be combined with smoke detectors to create a more effective fire detection system.

An infrared (IR) flame detector is a sensor 100 including a sensor element 101 that detects infrared radiation (heat) emitted by flames. Infrared flame detectors contain an emissive sensing element that converts infrared radiation into electrical output signals. Ultraviolet flame detectors use a combination of light sensors, filters, and photodetectors to detect the ultraviolet light emitted by flames. In an ultraviolet flame detector, a beam of light is directed through the area monitored by the detector and if an object blocks the light in any way, it will cause a break in the beam and trigger an alarm. The detector can also be used to detect smoke using an infrared filter that removes all visible light from the beam. Ultraviolet flame detectors can be suitable for use in areas with risk of fire or explosion, such as oil refineries, chemical plants and warehouses.

Combination Infrared and Ultraviolet Flame Detectors are a type of fire detector that uses ultraviolet and infrared light technology to detect the presence of flames. Combined infrared plus ultraviolet IR+UV flame detectors may be used in areas where there are sparks or flames, such as kitchens, bathrooms, garages, utility rooms and workshops.

In some embodiments, the sensor 100 for detecting fire may be linear infrared detectors. Linear infrared detectors (also referred to as “smoke or linear barriers”) are a type of detector that uses beams of infrared light to detect objects. The detector is made up of two parts: an emitter and a receiver. The emitter is a device that emits infrared rays, while the receiver detects the reflected rays. When an object obstructs the path between the emitter and the receiver, the light beam is interrupted. This interrupt is detected by the controller and used by the controller to trigger an alarm or other action.

In some embodiments, the sensor 100 for detecting fire may be a gas detector. Gas detectors can be used to detect the presence of combustible gases. Gas detectors can be designed to detect the presence of explosive and toxic gases. In one example, the gas detector may detect the presence of carbon monoxide (CO) gas. Gas detectors may be suitable for industrial applications, but are also becoming more common in residential applications.

Detector cable or temperature sensor for fire detection can be made up of two parts: a primary and a secondary conductor. The primary conductor may be composed of copper, while the secondary conductor may be composed of aluminum. The two conductors are separated by an insulator. There are two types of connection methods used for this type of detector: single pole and multipole connections.

It is noted that the above examples of sensors that can be used for the sensor 100 for engagement with the lighting structures 500 that are described herein are provided for illustrative purposes only, and it is not intended that the sensors 100 be limited to only the examples provided above.

FIGS. 14-21 illustrate some embodiments for the interface through which the sensor 100 may be reversibly engaged to the lighting structure 500.

For example, referring to FIGS. 7 and 14-16, in some embodiments, the sensor 100 includes a second retaining surface 137 configured to reversibly couple with the first retaining surface 507 in the port 505 of the lighting structure 500. The second retaining surface 137 of the sensor 100 may be a second thread that engages the first thread of the first retaining surface 507 in the port 505 of the lighting structure 500. For example, in some embodiments, the second thread of the second retaining surface 137 and first thread of the first retaining surface 507 reversibly mesh for physically engaging the sensor 100 to the port 505 of the lighting structure 500. The second retaining surface 137 is on the base portion 106 of the body 105 of the sensor 100, which provides the bottom interface of the sensor 100. More particularly, the second retaining surface 137 may be a thread that extends from a second face F2 on a sidewall S1 of the base portion of the body 105.

In some embodiments, the housing 105 of the sensor 100 that is depicted in FIGS. 7 and 14-16 may have a first diameter D1, in which the housing 105 includes an electrical interface end and a sensor element end. The electrical interface end may include the second face F2 of the housing 105. The electrical interface end can include a cylindrical boss C1. In some embodiments, the cylindrical boss C1 may include the sidewall S1 that includes the second thread for the second retaining surface 137 of the sensor 100, i.e., the cylindrical boss C1 can have a threaded sidewall. In some examples, the second thread of the sensor 100 is a male thread configuration, and the first thread of the port 505 of the lighting structure 500 is a female thread configuration. In some embodiments, the cylindrical boss C1 has a second diameter D2 that is less than the first diameter of the housing 105. The second diameter D2 of the cylindrical boss C1 and the male thread configuration for the second retaining surface 137 of the sensor 100 is configured for reversible engagement to the port 505 of the lighting structure 500 including a female thread configuration on the interior sidewall of the port 505 for intermeshing with the male thread configuration of the sensor. In some embodiments, the port 505 of the lighting structure 500 includes a recess for housing the second diameter D2 of the cylindrical boss C1.

The bottom interface of the sensor 100 includes both a physical interface and electrical interface for engagement of the sensor 100 to the lighting structure 500. For example, the second face F2 of the base portion 106 of the body 105 of the sensor 100 can include the sensor electrical interface 138. For example, the sensor electrical interface 138 can include a plurality of electrode pins (also referred to as pin electrodes 151), e.g., three electrode pins, which function as a plug that can reversibly mate with the power source interface 506 in the port 505 of the lighting structure 500, as depicted in FIGS. 7 and 14. In some embodiments, the pin electrodes 151 extending through a base surface (second face F2) of the cylindrical boss C1, in which the pin electrodes 151 configured for reversibly mating with the port electrical connector. The pin electrodes 151 are the electrodes of a plug component for the sensor 100 that in connected to the port 505 of the lighting structure 500 that functions as a socket.

In some examples, the power source interface 506 of the port 505 includes concentric electrodes 509 having a geometry for mating with the pin electrodes 151 of the sensor electrical interface 138. For example, the diameter for each of the concentric electrodes 509 is selected to correspond to the positioning of a pin electrode 151 relative to a rotational axis for installing the sensor 100 to the port of the lighting structure 500.

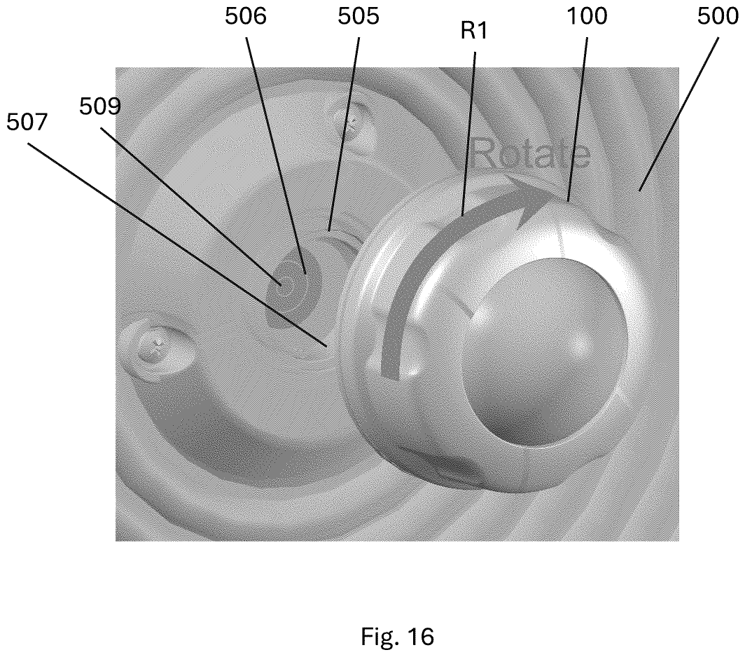

Referring to FIG. 16, for the embodiments in which the power source interface 506 of the port 505 for the lighting structure 500 includes three concentric electrodes 509, and the sensor electrical interface 138 includes three pin electrodes 151. The configuration of the concentric electrodes 509 and the pin electrodes 151 is selected to ensure that the pin electrodes 151 and concentric electrodes 509 are mated to one another as the sensor 100 is rotated R1 to engage the first thread for the first retaining surface 507 of the lighting structure 500 to the second thread of the second retaining surface 137 of the sensor 100. The sensor 100 depicted in FIG. 16 is only one example of a sensor 100 that may be used with the methods, system and structures of the present disclosure. It is not intended that the disclosure be limited to solely this embodiment.

FIGS. 8 and 17-19 illustrate another embodiment of a sensor 100, in which the sensor electrical interface 138 includes a male cylindrically shaped connector 152 extending through a base surface (second face F2) of the cylindrically shaped boss C1, the male cylindrically shaped connector 152 including a tip contact 153 and at least one ring contact 154, wherein the tip contact 153 is electrically isolated from the at least one ring contact 154, wherein the male cylindrically shaped connector 152 is configured for reversibly mating with the port 505, e.g., the port electrical connector. The elements that provide for physical engagement of the sensor 100 to the port 505 of the lighting structure 500 for the embodiments of the sensor 100 depicted in FIGS. 8 and 17-19, such as the cylindrically shaped boss C1 and the second retaining surface 137, e.g., second thread, are the same in the embodiments of the sensor depicted in FIGS. 7 and 14-16. Therefore, the description for the elements to provide for reversible physical engagement of the sensor 100 and the lighting structure 500 that are described for the embodiment depicted in FIGS. 7 and 14-16 are applicable to the embodiments depicted in FIGS. 8 and 17-19.

In the embodiment depicted in FIGS. 8 and 17, the plug element of the sensor 100 includes a male cylindrically shaped connector 152 including a tip contact 153 and at least one ring contact 154. The tip contact 153 and the at least one ring contact 154 may be useable as positive and negative contacts and a ground. Other jack plug arrangements, including at least two contacts (allowing for positive and negative electrical flow and data flow (e.g., signal over power data transmission)) may also be utilized. In some embodiments, the male cylindrically shaped connector 152 can include one, two, three or more ring contacts. For example, insulating material may be positioned between the tip contact 153 and the at least one ring contact 154 on the male cylindrically shaped connector 152 to provide for electrical isolation therebetween.

The port 505 of the lighting structure 500 includes a power source interface 506 that is configured to engage with the male cylindrically shaped connector 152 to provide for reversible electrical connection between the lighting structure 500 and the sensor 100. For example, the power source interface 506 of the port 505 includes a cylindrical jack 511 for receiving the male cylindrically shaped connector 152. The cylindrical jack 511 is positioned at the base of the port 505, wherein sidewalls of the port include the first engagement surface 537.

In some embodiments, the male cylindrically shaped connector 152 may be referred to as an audio jack plug, e.g., a 3.5 mm audio jack plug. For example, as shown in FIGS. 8 and 17-19, the power source interface 506 of the port 505 of the lighting structure 500 may function as a jack or socket, and the sensor electrical interface 138 provided by the male cylindrically shaped connector 152 of the sensor 100 may function as a plug in an audio jack and plug combination. As an audio jack and plug combination, the male cylindrically shaped connector 152 and the port 505 of the lighting structure 500 may be formed in accordance with any known standard including, but not limited to, WE-309, WE-310, BP0316, ETA RS-453, and IEC 60603-11.

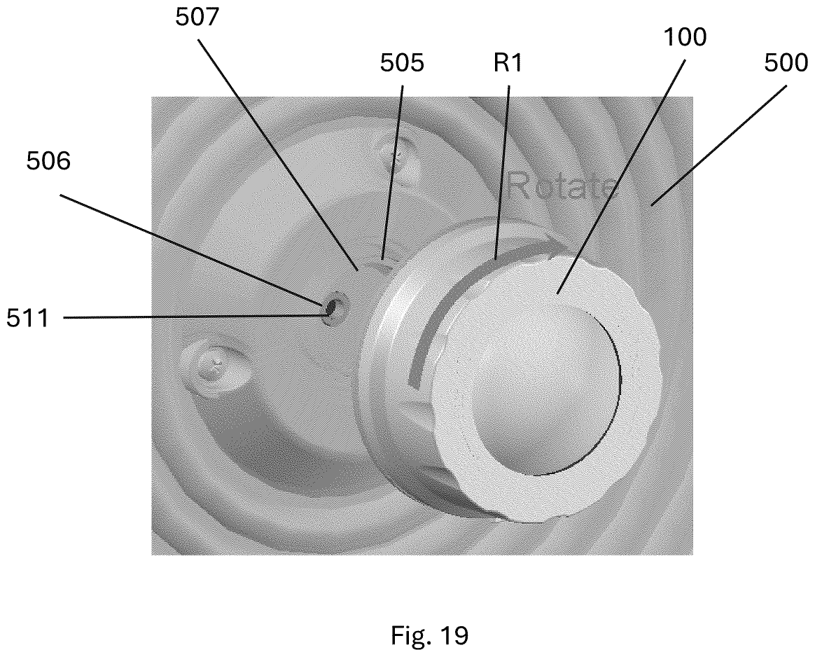

Referring to FIGS. 8 and 19, for the embodiments in which the power source interface 506 of the port 505 for the lighting structure 500 includes the male cylindrically shaped connector 152, the configuration of the port 505 of the lighting structure 500 and the cylindrically shaped boss C1 is selected to ensure that the male cylindrically shaped connector 152 and the cylindrical jack 511 in the part 505 are mated to one another as the sensor 100 is rotated R1 to engage the second thread of the second retaining surface 137 of the sensor 100 to the first thread for the first retaining surface 507 of the lighting structure 500. The sensor 100 depicted in FIG. 19 is only one example of a sensor 100 that may be used with the methods, system and structures of the present disclosure. It is not intended that the disclosure be limited to solely this embodiment.

FIGS. 20 and 21 illustrate yet another embodiment of an interface at which the sensor 100 and the lighting structure 500 are reversibly connected to one another. In the embodiment that is depicted in FIG. 20, the power source interface 506 of the lighting structure 500 includes a first electrical socket engagement electrode 519. The electrical first electrical socket engagement electrode 519 is a socket that provides not only electrical engagement between the lighting structure 500 and the sensor 100, but also provides for physical engagement between the lighting structure 500 and the sensor 100. For example, the first electrical socket engagement electrode 519 of the port 505 comprises an internal latch. portion for receiving the second electrode engagement surface 163 of the electrodes 162 of the sensor electrical interface 138 for the sensor 100. The first electrical socket engagement electrode 519 provides for both electrical connection, and physical connection of the sensor 100 to the lighting structure 500.

The port 505 of the lighting structure 500 may also include a second mechanism for physical engagement of the lighting structure 500 to the sensor 100. For example, the port 505 includes collar 514 having an exterior sidewall having at least one retaining slot 515. The first electrical socket engagement electrode 519 of the port 505 may be centrally positioned on the collar 514. The at least one retaining slot 515 is configured for receiving a retaining tab 165 of the sensor 100. For example, the at least one retaining slot 515 may include a vertically orientated insertion portion and a horizontally orientated locking portion for receiving and retaining the retaining tab 165.

FIG. 21 illustrates a sensor 100 for engagement to the port 505 of the lighting structure 500 that is depicted in FIG. 20. FIG. 21 illustrates a sensor 100 that includes a housing 105 with an electrical interface end including electrodes 162 with a second electrode engagement surface 163 that includes a horizontally orientated retention beam for engaging the first electrical socket engagement electrode 519 of the lighting structure 500. In some embodiments, the electrodes 162 may be curved blade electrodes.

The electrical interface end of the housing 105 for the sensor 100 also includes a cylindrical receiving boss 164 including an internal sidewall S2 with at least one retaining tab 165. The cylindrical receiving boss 164 of the sensor 100 defines an opening for housing the collar 514 of the port 505 of the lighting structure 500. For example, the cylindrical receiving boss can define a cylindrical recess (opening) including an internal sidewall S2 with at least one retaining tab 165. In some embodiments, the cylindrical recess of the housing 105 is a counterbore dimensioned to house a cylindrical protrusion (also referred to as the collar 514) of the port 505. In some embodiments, the at least one retention tab 165 is present on a sidewall of the counterbore. In some embodiments, the at least one retaining tab 165 is configured for reversible engagement to at least one retaining slot 515 in the port 505 of the lighting structure 500.

Still referring to FIG. 21, the electrodes 162 of the sensor 100 extend through a base surface of the cylindrical recess at the electrical interface end of the housing 105. The electrodes 162 include vertically orientated portion extending from the base surface of the cylindrical recess, and a horizontally orientated retention beam (second electrode engagement surface 163) at an opposing end of the vertically orientated portion of the electrodes from the base surface of the cylindrical recess. In some embodiments, the horizontally orientated retention beam of the electrodes 162 of the sensor 100 are configured to reversibly lock into the latch portion of the first electrical socket engagement electrode 519 in the port 505 of the lighting structure 500 with rotation motion.

In some embodiments, rotational movement applied to the sensor 100 relative to the lighting structure 500, as the sensor 100 is being inserted into the port 505 engages the horizontally orientated retention beam of the electrode 162 into reversible locking engagement with the latch of the first electrical socket engagement electrode 519 in the port 505 of the lighting structure 500. In some embodiments, the latch of the first electrical socket engagement electrode 506 within the port 505 and the horizontally orientated beams of the second electrode engagement surface (second electrode engagement surface 163) of the electrode 162 are elements of a twist lock electrode plug. The horizontally orientated beams provide end portions of an electrode 162 from the sensor electrical interface 138 that engages the power source interface 506 of the port 505 in the lighting structure 500. In some embodiments, the electrode 162 of the sensor 100 and the first electrical socket engagement electrode 519 provides that the plug of the sensor 100 and the jack of the port 505 joins together by forming a tapered contact. In some embodiments, the electrodes 162 of the sensor 100 have straight plug with “L” shaped curved blades. The “L” shape locks behind the receptacle face of the power source interface 506 of the port 505 when inserted into the mating slot provided by the first electrical socket engagement electrode 519. When rotated, the blades slide behind the receptacle face, locking the two connectors together. To unlatch the plug, the rotation is reversed. In some embodiments, the twist lock arrangements can include a Zhaga connection type arrangement. A Zhaga type connection corresponds to the standard set by the Zhaga Consortium. The Zhaga Consortium is a global, open lighting industry organization that develops and promotes standardized interfaces for LED luminaire components.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A lighting system comprising:
a lighting structure comprising:
a housing comprising a lighting structure electrical interface and a light emission end,
a light engine within the housing comprising solid state emitters configured to emit light through the light emission end of the housing;
a port including a first retaining surface and a power source interface, the port positioned for access to an ambient at an exterior of the housing, and
driver electronics in electrical communication with the lighting structure electrical interface of the housing, the driver electronics including a first power circuit to the light engine, and a second power circuit to the power source interface of the port; and
a sensor comprising:
a sensor element for reading elements from the ambient,
a second retaining surface configured to reversibly couple with the first retaining surface in the port of the lighting structure,
a sensor electrical interface to reversibly mate with the power source interface in the port of the lighting structure, and
a rechargeable sensor power source in electrical communication with the second power circuit of the driver electronics in the lighting structure thorough the sensor electrical interface.

2. The lighting system of claim 1, wherein the light engine comprises a substrate that the solid state emitters are positioned on, wherein the port is present on the substrate.

3. The lighting system of claim 1, wherein the solid state emitters are present on a face surface of a substrate facing the light emission end of the housing, and the port is positioned within a perimeter of the solid state emitters.

4. The lighting system of claim 1, wherein the first retaining surface comprises a first thread, and the second retaining surface comprises a second thread, wherein the first thread and second thread reversibly mesh for engaging the sensor to the port of the lighting structure.

5. The lighting system of claim 4, wherein the sensor includes a sensor housing with a first face including a sample collection surface for the sensor element, and a second face including the sensor electrical interface, wherein a sidewall of the sensor housing between the first face and the second face includes the second thread.

6. The lighting system of claim 1, wherein the sensor electrical interface comprises a male cylindrically shaped connector including a tip contact and at least one ring contact, wherein the tip contact is electrically isolated from the at least one ring contact.

7. The lighting system of claim 6, wherein the power source interface of the port comprises a cylindrical jack for receiving the male cylindrically shaped connector, the cylindrical jack positioned at a base of the port, wherein sidewalls of the port include the first retaining surface.

8. The lighting system of claim 1, wherein the power source interface of the sensor includes pin electrodes, and the power source interface of the port includes concentric electrodes having a geometry for mating with the pin electrodes.

9. The lighting system of claim 1, wherein the sensor is selected from the group consisting of dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof.

10. The lighting system of claim 1, wherein the rechargeable sensor power source is a battery.

11. A lighting system comprising:
a light structure comprising:
a housing comprising an lighting structure electrical interface and a light emission end,
a light engine within the housing comprising solid state emitters configured to emit light through the light emission end of the housing;
a port including a power source interface, the port positioned for measuring an ambient from an exterior of the housing, and the power source interface including a first retaining surface, and
driver electronics in electrical communication with the lighting structure electrical interface of the housing, the driver electronics including a first power circuit to the light engine and a second power circuit to the power source interface of the port; and
a sensor comprising:
a sensor element for reading elements from the ambient,
a sensor electrical interface comprising electrodes having a second retaining surface configured to reversibly couple with the first retaining surface in the power source interface of the port of the lighting structure, and
a rechargeable sensor power source in electrical communication with the second power circuit of the driver electronics in a lighting structure thorough the sensor electrical interface when reversibly mated with the power source interface.

12. The lighting system of claim 11, wherein the first retaining surface of the port comprises a latch, and the second retaining surface of the electrodes of the sensor electrical interface includes a horizontally orientated retention beam, wherein rotational movement engages the horizontally orientated retention beam into reversible locking engagement with the latch of the port of the lighting structure.

13. The lighting system of claim 12, wherein the latch and the horizontally orientated retention beam are elements of a twist lock electrode plug, wherein the horizontally orientated retention beam are end portions of an electrode from the sensor electrical interface that engages the power source interface of the port in the lighting structure.

14. The lighting system of claim 11, wherein the light engine comprises a substrate that the solid state emitters are positioned on, wherein the port is present on the substrate.

15. The lighting system of claim 14, wherein the solid state emitters are present on a face surface of the substrate facing the light emission end of the housing, and the port is positioned within a perimeter of the solid state emitters.

16. The lighting system of claim 11, wherein the sensor is selected from the group consisting of dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof.

17. A sensor comprising:
a housing having a first diameter, the housing including an electrical interface end and a sensor element end, the electrical interface end including a cylindrical boss with a threaded sidewall, the cylindrical boss having a second diameter that is less than the first diameter, the second diameter and male thread size for the threaded sidewall configured for reversible engagement of the cylindrical boss to a lighting structure port, wherein the lighting structure port includes a mating female thread size, recess for housing the second diameter of the cylindrical boss, and a port electrical connector;
pin electrodes extending through a base surface of the cylindrical boss, the pin electrodes configured for reversibly mating with the port electrical connector;
a sensor element positioned to take samples from an ambient through the sensor element end of the housing, the sensor element in electrical communication with the pin electrodes; and
a rechargeable power source within the housing, the rechargeable power source in electrical communication with the pin electrodes and the sensor element.

18. The sensor of claim 17, wherein the pin electrodes include three pins having a spacing for reversibly mating to three concentric electrodes of the port electrical connector.

19. The sensor of claim 17, wherein the sensor element is selected to provide that the sensor has a type selected from the group consisting of dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof.

20. The sensor of claim 17, wherein the rechargeable sensor power source is a battery.
